(19) United States
(12) Patent Application Publication
(10) Pub. No.: US 2003/0166840 A1
(43) Pub. Date: Sep. 4, 2003

(54) PHOTORESPONSIVE POLYMERS

(76) Inventors: Dan W. Urry, Birmingham, AL (US); David A. Tirrell, Sunderland, MA (US); Catherine Jean Heimbach, Birmingham, AL (US)

Correspondence Address: COOLEY GODWARD LLP, ATTN: PATENT GROUP, FIVE PALO ALTO SQUARE, 3000 EL CAMINO REAL, PALO ALTO, CA, 94306-2155, US

(21) Appl. No.: 09/759,947

(22) Filed: Jan. 12, 2001

Related U.S. Application Data
(63) Continuation of application No. 09/032,373, filed on Feb. 27, 1998, now abandoned.
Application No. 09/032,373 is a continuation of application No. 08/485,426, filed on Jun. 7, 1995, now abandoned.
Application No. 08/485,426 is a division of application No. 08/187,441, filed on Jan. 24, 1994, now abandoned.

(51) Int. Cl. C07K 16/00

(52) U.S. Cl. 530/350; 430/269

(57) ABSTRACT

A composition that expands or contracts upon a change in exposure to light energy is provided that comprises a protein or protein-based polymeric material having an inverse temperature transition in the range of liquid water, wherein at least a fraction of the monomers in the polymer contain an light energy-responsive group that undergoes a change in hydrophobicity or polarity upon a change in exposure to light energy and is present in an amount sufficient to provide a shift in the inverse temperature transition of the polymer upon the change in exposure to light energy. Compositions of the invention, including those further containing a side-chain chemical couple, can be used in a variety of different applications to produce mechanical work, cause turbidity changes, cause chemical changes in an enclosed environment, or transduce other free energies by varying the exposure to light energy on the composition. The degree and efficiency of mechanical or chemical change can be controlled by, inter alia, selection of the type, amount, position, and mole fraction of the light energy-responsive side chain group and hydrophobic residues in the polymer.

This work was supported in part by the NSF Materials Research Laboratory at the University of Massachusetts and by Contract Nos. N00014-90-C-0265 and N00014-89-J-1970 from the Department of the Navy, Office of Naval Research. Accordingly the Government of the United States may have certain rights in this invention as a result of governmental support.

### INTRODUCTION

1. Technical Field

The present invention is directed to the field of polymers and to uses thereof that depend on the ability of the polymers to respond to light.

2. Background

Bioelastomeric polypeptides are a relatively new development that arose in the laboratories of one of the present inventors (Dan W. Urry) and which are disclosed in a series of previously filed patents and patent applications. For example, U.S. Pat. No. 4,474,851 describes a number of tetrapeptide and pentapeptide repeating units that can be used to form a bioelastic polymer. Specific bioelastic polymers are also described in U.S. Pat. Nos. 4,132,746, 4,187,852, 4,589,882, and 4,870,055. U.S. Pat. No. 5,064,430 describes polynonapeptide bioelastomers. Bioelastic polymers are also disclosed in related patents directed to polymers containing peptide repeating units that are prepared for other purposes but which can also contain bioelastic segments in the final polymer: U.S. Pat. Nos. 4,605,413, 4,976,734, and 4,693,718, entitled “Stimulation of Chemotaxis by Chemotactic Peptides”; U.S. Pat. No. 4,898,926, entitled “Bioelastomer Containing Tetra/Pentapeptide Units”; U.S. Pat. No. 4,783,523 entitled “Temperature Correlated Force and Structure Development of Elastin Polytetrapeptide”; U.S. Pat. Nos. 5,032,271, 5,085,055 and 5,255,518, entitled “Reversible Mechanochemical Engines Comprised of Bioelastomers Capable of Modulable Temperature Transitions for the Interconversion of Chemical and Mechanical Work”; U.S. Pat. No. 4,500,700, entitled “Elastomeric Composite Material Comprising a Polypeptide”; and U.S. Pat. No. 5,520,516 entitled “Bioelastomeric Materials Suitable for the Protection of Wound Repair Sites.” A number of other bioelastic materials and methods for their use are described in pending U.S. patent applications including: U.S. Ser. No. 184,873, filed Apr. 22, 1988, entitled “Elastomeric Polypeptides as Vascular Prosthetic Materials”; and U.S. Ser. No. 07/962,608, filed Oct. 16, 1992, entitled “Bioelastomeric Drug Delivery System.” All of these patents and patent applications are herein incorporated by reference, as they describe in detail bioelastomers and/or components thereof and their preparation that can be used in the compositions and methods of the present invention. These bioelastic materials have been proposed for a number of uses and apparatuses, as indicated by the general subject matter of the applications and patents set forth above. The bioelastic compositions and machines, which arose in the laboratories of one of the present inventors, respond to pressure, chemical, and/or thermal changes in the environment by phase transitions (e.g. viscosity or turbidity changes) or by contraction or relaxation to reversibly transduce these energies into mechanical work. For example, polymers and machines capable of baromechanical (pressure-to-mechanical), barochemical, and barothermal transductions have uses that include sensors, actuators and desalinators (See U.S. Pat. No. 5,226,292, which is incorporated herein by reference).

There are a number of publications that describe polymers having the ability to respond to light in some predetermined fashion. U.S. Pat. No. 4,732,930 discloses ionized isopropylacrylamide gels capable of volume changes in response to solvent composition, temperature, pH or ion composition. U.S. Pat. No. 4,826,954 discloses a diorganopolysiloxane-azobenzene alternating copolymer (having azobenzene in the polymer backbone) whose viscosity and absorption spectrum changes upon exposure to ultraviolet and visible light. Photomechanical transduction was reported for a modified poly(N-isopropylacrylamide) copolymer gel (38; WO 91/05816). However, the specifically embodied copolymer gel was not well characterized and displayed significant hysteresis, a property that would adversely affect control and reproducibility of the phase transition or swelling/contracting. In addition, the possibility for attaining and finely adjusting features such as defined polymer size, half-life in a biological environment, and variations in composition are expected to be limited or difficult to achieve with random structured polymers such as the disclosed acrylamide based polymer.

Accordingly, a need still exists for elastomeric polymers in which phase transitions, mechanical activity, or free energy transductions are induced and modulated in a relatively clean, remote, and precise fashion, at a macro or micro level, and in which properties including bio-compatibility, hysteresis, half-life, elastic modulas, defined polymer size, efficiency of energy conversion, biological function (e.g. chemotaxis), and polymer structure can be readily achieved and finely adjusted. The present invention provides these and other advantages by providing protein and protein-based bioelastic polymers that are responsive to environmental changes in light energy, particularly in the ultraviolet, visible or infrared spectral ranges, to transduce light energy into useful work, and by providing machines containing these polymers.

### LITERATURE

Reference is made in the following specification to the following publications by giving the publication number in parentheses at the location where cited.

1. Urry, D. W., (1988) J. Protein Chem. 7:1-34.

2. Urry, D. W., (1989) J. Protein Chem. 7:81-114.

3. Urry, D. W., (1990) American Chemical Society, Div. of Polymeric Materials: Sci. and Engineering 62.

4. Hollinger, J. O., Schmitz, J. P., Yaskovich, R., Long, M. M., Prasad, K. U., and Urry, D. W., (1988) Calacif. Tissue Int. 42:231-236.

5. Urry, D. W., (1988) Intl. J. Quantum Chem.: Quantum Biol. Symp. 15:35-245.

6. Edsall, J. T. and McKenzie, H. A., (1983) Adv. Biophys. 16:3-183.

7. Kauzman, W., (1959) Adv. Protein Chem. 14:-63.

8. Urry, D. W., Luan, C. H., Harris, R. Dean, and Prasad, Karl U., (1990) Polymer Preprint Am. Chem. Soc. Div. Polym. Chem. 31:188-189.

9. Urry, D. W., (1984) J. Protein Chem. 3:403-436.

10. Chang, D. K., Venkatachalam, C. M., Prasad, K. U., and Urry, D. W., (1989) J. of Biomolecular Structure & Dynamics 6:851-858.

11. Chang, D. K. and Urry, D. W., (1989) J. of Computational Chemistry 10:850-855.

12. Urry, D. W., Haynes, B., Zhang, H., Harris, R. D., and Prasad, K. U., (1988) Proc. Natl. Acad. Sci. USA 85:3407-3411.

13. Urry, D. W., Peng, Shao Qing, Hayes, Larry, Jaggard, John, and Harris, R. Dean, (1990) Biopolymers 30:215-218.

14. Sidman, K. R., Steber, W. D., and Burg, A. W., (1976) In Proceedings, Drug Delivery Systems (H. L. Gabelnick, Ed.), DHEW Publication No. (NIH) 77:-1238, 121-140.

15. Urry, D. W., Chang, D. K., Zhang, H., and Prasad, K. U., (1988) Biochem. Biophys. Res. Commun. 153:832-839.

16. Robinson, A. B., (1974) Proc. Nat. Acad. Sci. USA 71:885-888.

17. Urry, D. W. (1982) In Methods in Enzymology, (L. W. Cunningham and D. W. Frederiksen, Eds.) Academic Press, Inc. 82:673-716.

18. Urry, D. W., Jaggard, John, Harris, R. D., Chang, D. K., and Prasad, K. U., (1990) In Progress in Biomedical Polymers (Charles G. Gebelein and Richard L. Dunn, Eds.), Plenum Publishing Co., N.Y. pp. 171-178.

19. Urry, D. W., Jaggard, J., Prasad, K. U., Parker, T., and Harris, R. D., (1991) in Biotechnology and Polymers, (C. G. Gebelins, ed.), Plenum Press., N.Y. pp. 265-274.

20. Urry, D. W., Harris, R. D., and Prasad, K. U. (1988) J. Am. Chem. Soc. 110:3303-3305.

21. Sciortino, F., Palma, M. U., Urry, D. W., and Prasad, K. U., (1988) Biochem. Biophys. Res. Commun. 157:1061-1066.

22. Sciortino, F., Urry, D. W., Palma, M. U., and Prasad, K. U., (1990) Biopolymers 29:1401-1407.

23. Pitt, C. G. and Schindler, A., (1980) In Progress in Contraceptive Delivery Systems (E. Hafez and W. Van Os, Eds.), MTP Press Limited 1:17-46.

24. Urry, D. W. (1990) Mat. Res. Soc. Symp. 174:243-250, and references therein.

25. Urry, D. W. (1990) Expanding Frontiers in Polypeptide and Protein Structural Research in Proteins: Structure, Dynamics and Design, (V. Renugopalakrishnan, P. R. Carey, S. G. Huang, A. Storer, and I. C. P. Smith, Eds.) Escom Science Publishers B. V., Leiden, The Netherlands (1991) pp. 352-360.

26. Bungenberg de Jong, H. G. and Kruyt, H. R. (1929) Proc. Kon. Ned. Akad. Wet. 32:849.

27. Bungenberg de Jong, H. G. and Kruyt, H. R. (1930) Kolloid-Z 50:39.

28. Bungenberg de Jong, H. G., (1949) in Colloid Sci. (H. R. Kruyt, Ed.) Elsevier, Amsterdam, Vol. 2, Chap. VIII, p. 232.

29. Luan, C. H. and Urry, D. W. (1991) “Solvent Deuteration Enhancement of Hydrophobicity: DSC Study of the Inverse Temperature Transition of Elastin-based Polypeptides” J. Phys. Chem. 95:7896-7900.

30. Luan, C. H., Jaggard, J. J., Harris, R. D., and Urry, D. W. (1989) Intl. J. of Quantum Chem.: Quantum Biol. Symp. 16:235-244.

31. Urry, D. W., Luan, C. H., Parker, T. M., Gowda, D. C., Prasad,. K. U., Reid, M. C., and Safavy, A. (1991) J. Am. Chem. Soc. 113:4346-4348.

32. Urry, D. W., Trapane, T. L., and Prasad, K. U. (1985) Biopolymers 24:2345-2356.

33. Urry, D. W. (1993) Angew. Chem. Int. Ed. Engl. 32:819-841.

34. Urry et al. (1993) J. Am. Chem. Soc. 115:7509-7510.

35. Urry, D. W., Hayes, L. C., Gowda, D. C., Parker, T. M. (1991) Chem. Phys. Lett. 182, 101-106.

36. Urry, D. W., Hayes, L. C., Gowda, D. C., Harris, C. M., Harris, R. D. (1992) Biochem. Biophys. Res. Comm. 188, 611-617.

37. Pattanaik, A., Gowda, D. C., Urry, D. W. (1991) Biochem. Biophys. Res. Commun. 178, 539-545.

38. Irie, M. (1990) Pure and Appl. Chem. 62, 1495-1502.

39. Urry, D. W., Peng, S. Q., Parker, T. M. (1992) Biopolymers 32, 373-379.

40. Fissi, A., Pieroni, O. (1989) Macromolecules 22, 115-1120.

41. Ferritto, M. S., Tirrell, D. A. (1990) Biomaterials 11, 645-651.

42. Brown, C. (1966) Acta Crystallogr. 21, 146-152.

43. Urry, D. W., Luan, C. H., Parker, T. M., Gowda, D. C., Prasad, K. U., Reid, M. C., Safavy, A., (1991) J. Am. Chem. Soc. 113, 4356-4348.

44. Urry, D. W., Gowda, D.C., Parker, T. M., Luan, C. H., Reid, M. C., Harris, C. M.; Pattanaik, A.; Harris, R. D. (1992) Biopolymers 32:1243-1250.

45. Schild, H. G. (1992) Prog. Polym. Sci. 17:163-249.

46. Urry et al. (1981) J. Am. Chem. Soc. 103:2080-2089.

47. Urry et al. (1993) Chem. Phys. Lett. 201:336-340.

48. Katchalsky, et al. (1960) in Size and Shape of Contractile Polymers: Conversion of Chemical and Mechanical Energy (ed. Wasserman) Pergamon, N.Y., pp 140.

49. Katchalsky et al. (1951) J. Polym. Sci. 7:383-412.

50. Kuhn et al. (1950) Nature 165:514-516.

51. Urry (1992) Prog. Biophys. Mol. Biol. 57:23-57.

52. Urry et al. (1992) J. Am. Chem. Soc. 114:8716-8717.

### SUMMARY OF THE INVENTION

The present invention is directed to new bioelastomers and to a new use of bioelastic materials, namely as part of a system in which mechanical, chemical, electrical or pressure-related work occurs (or any or all occur) as a result of a response by the bioelastic material to light energy (or vice versa; i.e., the process can be reversible), particularly from the visible, ultraviolet or infrared spectra. The response is typically a chemical change (bond formation or breaking). The invention provides protein and protein-based bioelastomers that can undergo a phase transition, such as a phase separation, free energy transduction, or contraction or relaxation in response to a change in exposure to light energy.

It is an object of the invention to provide design parameters by which the conditions under which phase transition, free energy transduction, or contraction and expansion of a composition of the invention can be finely controlled and adjusted.

These and other objects of the present invention as will hereinafter become more readily apparent have been accomplished by providing a composition capable of undergoing a phase transition, an absorbance change, or contraction or relaxation in response to a change in light energy, which composition includes a protein or protein-based bioelastic polymer containing elastomeric units selected from the group consisting of bioelastic peptide units, wherein at least a fraction of the bioelastic units contain at least one amino acid residue having a side chain substitution reactive to light energy to effect a change in the polarity or hydrophobicity of the side chain in an amount sufficient to provide photo-induced modulation of the inverse temperature transition of the bioelastic polymer. Preferred bioelastic peptide units are bioelastic tetrapeptides, pentapeptides, and nonapeptides.

Another object of the invention is to provide compositions capable of Tₜ-type second order energy transductions involving light energy. Such compositions include a photoresponsive protein or protein-based bioelastomer wherein a bioelastic unit further includes a second amino acid residue having a side chain or substituted side chain capable of undergoing a change in an aqueous environment (e.g. chemical, electrical, or conformational change) in response to the photo-induced response of the first photoresponsive side chain. The bioelastic unit with the second amino acid can be the same unit that contains the photoresponsive sid chain or can be a separate unit (e.g. in a copolymer).

The transition characteristics of the bioelastomers can be controlled by changes including (a) appropriately varying the chemical composition of the photoreactive side chain(s) or second side chain(s) couple to effect a change in the hydrophobicity and/or polarity of the photoresponsive side chain upon exposure to light energy or in the second side chain couple, (b) varying the mole fraction of the photoresponsive side chain substituent units in the overall polymer, (c) varying the mole fraction of the second side chain couple, (d) varying the composition of the other amino acid residues, (e) varying the location, orientation and attachment of the photoresponsive side chain(s) in relation to the second side chain couple, (f) varying the overall hydrophobicity of the bioelastic unit, and (g) varying the number, location, orientation and attachment of other hydrophobic side chain(s) in relation to the second side chain couple.

The bioelastic polymers as described herein can be used in methods and apparatuses in which mechanical, chemical, pressure-related, thermal or electrical changes occur as a result of changes in the polymer upon a change in exposure to light energy. The photo-response (and subsequent polymer activity) can be made either reversible or irreversible by choice of photoresponsive substituents and second couple substituent.

It is a further object of the invention to provide protein and protein-based first-order molecular machines of the Tₜ-type capable of photomechanical transduction in response to a change in exposure to light energy to produce useful work.

It is a further object of the invention to provide protein and protein-based second-order molecular machines of the Tₜ-type capable of photochemical, photothermal, photoelectrical, or photobaric energy transductions in response to a change in exposure to light energy to produce useful chemical, thermal, electrical or pressure-related work.

The photoresponsiveness of the protein and protein-based bioelastic polymers of the invention and apparatuses comprising them allows relatively clean, remote and precise induction and modulation of polymer properties, at both the micro and macro level. By remote is meant that the polymer can be modulated without direct physical contact with it or its aqueous environment. The folding and unfolding of the bioelastic polymers of the invention do not display hysteresis, and accordingly the energy transductions and work produced by the bioelastic polymers is repeatedly and reproducibly attained. In addition, the chemical and physical structure of the bioelastic polymers of the invention can be readily adjusted to “poise” the bioelastic polymer to enhance or reduce the extent of folding or unfolding (and thus work produced) in response to light energy. In polymers of the invention capable of undergoing Tₜ-type second order photochemical transductions poising provides more efficient conversion of light energy into chemical energy. Protein and protein-based bioelastic polymers as taught herein can be designed to have numerous advantages including biological stability, biological function, and defined polymer size. These advantages are achieved in the present invention by providing polymers composed of easily obtained and coupled monomer units, i.e. amino acids, that are themselves diverse in structure and in chemical properties, and whose side chain groups can be readily modified to contain groups selected from the vast array of well-studied photoresponsive molecules. Furthermore, recombinant peptide-engineering techniques can be advantageously used to produce specific bioelastic peptide backbones, either the, bioelastic units or non-elastic biofunctional segments, which can be chemically modified to contain photoresponsive groups.

### DESCRIPTION OF THE DRAWINGS

The present invention will be better understood by reference to the following detailed description of the invention and the drawings which form part of the present specification, wherein:

FIG. 1 depicts an electronic absorption spectra of a bioelastomer of formula II after irradiation at 350 nanometers (“nm”) or from the electronic flash unit: (a) dark-adapted 24 hours; (b) 5 seconds at 350 nm; (c) 20 seconds at 350 nm; (d) 45 seconds at 350 nm; (e) 15 flashes at 1 flash/second; (f) 45 flashes at 1 flash/second. The flash unit was a Rayonet Mini Reactor with a 350 nm lamp.

FIG. 2 depicts a graph of the temperature-dependent turbidity of aqueous samples of the bioelastomer of formula II (concentration=5 mg/ml in pH 4.1 phosphate buffered saline solution). Transmission values were obtained on a Beckman DU-7 spectrophotometer with a Lauda K4/RD circulating bath: (□) dark-adapted 24 hrs; (♦) flashed 45 times.

FIG. 3 is a graph showing photo-modulation of phase separation of aqueous samples of the bioelastomer of formula II (concentration=5 mg/ml in pH 4.1 phosphate buffered saline solution, 40° C.). “70% cis” samples were prepared by irradiation for 5 minutes at 350 nm; “50/50” sample (50% cis and 50% trans) was prepared by irradiation with 50 flashes from the electronic flash unit. The “trans” sample was dark adapted before irradiation. Hatched intervals represent the periods of irradiation at 350 nm.

FIG. 4 is a graph showing the relationship of mole fraction of hydrophobic or polar units and the relative hydrophobicity or polarity of those units on the temperature of the inverse temperature transition.

FIG. 5 is a schematic diagram of an apparatus of the invention in which either mechanical work (moving an object) or chemical work (detectable through a pH meter) are achieved by a change in light energy.

FIG. 6 is a schematic diagram of a light meter that operates using a composition of the invention.

FIG. 7 is a graph showing the non-linear relationship between bioelastomeric unit hydrophobicity (exemplified by the number of phenylalanine residues present in the unit) and hydrophobic-induced pKa shift.

FIG. 8 is a schematic depicting energy transductions of the Tₜ type.

### DESCRIPTION OF SPECIFIC EMBODIMENTS

The light induced efects of the present invention occur in protein and protein-based bioelastic polymers that display an inverse temperature transition. Preferably the transition occurs in the range of liquid water. Protein and protein-based bioelastic polymers that exhibit an inverse temperature transition, which is a phase transition to a condensed state of greater order in water as temperature increases, are typically polymers that contain both polar and hydrophobic regions. These bioelastic polymers are described in detail herein, but are also described (without the photoreactive group) in the various patents and other documents listed above that arose in the laboratories of the present inventors. It has been found that when a bioelastic polymer side chain that is responsive to a change in exposure to light energy, preferably from the visible, ultraviolet, or less preferably infrared spectrum, undergoes a change in its hydrophobicity and/or polarity upon a change in exposure to light energy, the bioelastomer exhibits an inverse temperature transition. Infrared light energy can be useful in the case of delocalized systems such as ion pairing and also to generate photo-isomerization. Light energy is that electromagnetic radiation energy from the visible, ultraviolet or infrared spectrum. Visible light, visible to the human eye, extends from about 380 to 760 nm. Ultraviolet light extends from about 380 nm to 9 nm, with the near UV (about 380 nm to 200 nm) being preferred UV light. Infrared light extends from about 760 nm to about 300 μm, however the preferred range is from 760 nm to about 60 μm, and most preferred in the near IR from about 760 nm to 2.5 μm. Metzler ((1977) Biochemistry: The Chemical Reactions of Living Cells, Academic Press, NY, p 744-804) provides electromagnetic radiation spectral frequencies and is incorporated herein by reference. Useful light energy is that which causes a photoresponse in a side chain group of a bioelastic polymer to result in a hydrophobicity or polarity change in that side chain sufficient to effect a change in the folding, unfolding, assembly or unassembly of the bioelastic polymer. The source of light energy, which can include lasers, is not critical and can depend on the particularly use and type of bioelastic polymer of the invention. The phase of light is not crticial and can include incoherent, coherent, or polarized light.

Photoresponsive side chains and their substituents are chosen to result either in an increase in the temperature at which the bioelastomer folds (Tₜ) or a decrease in Tₜ. Thus, in response to a change in exposure to light energy, a bioelastomer can either expand or contract, or undergo a phase transition, resulting, for example, in a turbid or a non-turbid solution. A bioelastic polymer of the invention can contain more than one type of photoresponsive side chain, which can differ, for example, by the wavelength of light energy necessary to cause each photoresponse.

By responsive to light energy is meant that a chemical reaction, e.g. ionization, oxidation, reduction, protonation, cleavage, phosphorylation, etc., configurational, e.g. cis-to-trans isomerization, or other chemical change occurs to the side chain group upon a change in exposure to light energy, e.g. change in intensity, frequency, wavelength, or presence or absence of radiation.

In addition, since the Tₜ of a protein or protein-based bioelastomer of the invention can be modulated by a change in exposure to light energy (in essence the light energy results in a variation in the polymer composition without synthesis of a new polymer), the response, e.g. contraction/expansion, phase transition, of the bioelastomer to extrinsic or intrinsic changes, e.g. pressure, pH, salt, concentration, organic solutes, is in turn modulable. This property can now be put to use to achieve mechanical, chemical, thermal or pressure-related work, as described herein.

The photoresponsive protein and protein-based bioelastic polymers of the invention have the unexpected property of “poising,” e.g. the same amount of change in hydrophobicity induced by the light energy reaction causes a relatively larger effect in polymer response, if the hydrophobicity change is selected (i.e. poised) to occur at a pre-selected value relative to other values where little change occurs. Transduction of light energy is more efficient in poised polymers. Poising the photoresponsiveness of the bioelastomer can be achieved by increasing the overall hydrophobicity of the bioelastic unit when the photoresponse results in an increase in hydrophobicity of the photoresponsive side chain. Poising is also achieved by positioning a greater number of hydrophobic groups in closer proximity to the photoresponsive unit undergoing a hydrophobicity change or to the second side chain couple present in polymers for Tₜ-type second order phototransductions. Alternatively, poising is achieved by increasing or positioning polar groups in the elastomeric unit when the photoresponsive group undergoes an increase in polarity.

Although the invention can be carried out with a number of different protein or protein-based polymers, this specification exemplifies the invention by concentrating on the class of polymers originally identified by the inventor and subsequently modified as taught herein to provide new photoresponsive compounds, compositions, and apparatuses of the invention.

Bioelastic polypeptides have been previously characterized and described in a number of patents and patent applications described above. These materials contain either tetrapeptide, pentapeptide, or nonapeptide monomers which individually act as elastomeric units within the total polypeptide containing the monomeric units. The elasticity of the monomeric units is believed to be due to a series of β-turns in the protein's secondary structure, i.e., the conformation of its peptide chain, separated by dynamic (as opposed to rigid) bridging segments suspended between the β-turns. A β-turn is characterized by a 10-atom hydrogen-bonded ring of the following formula:

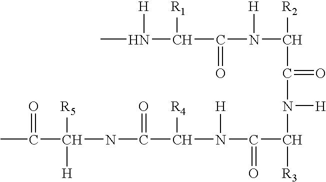

In this formula R₁-R₅ represent the side groups of the respective amino acid residues. The 10-atom ring consists of the carbonyl oxygen of the first amino acid, the amino hydrogen of the fourth amino acid, and the intervening backbone atoms of amino acids two and three. In this monomeric unit as shown, the remaining backbone atoms of the chain (the remainder of amino acid four, amino acid five, and the first part of amino acid one of the next pentameric unit) form the bridging segment that is suspended between adjacent β-turns. Similar structures are present in elastomeric peptide units of other lengths. Other peptide structures, such as β-barrels, can also impart elasticity to bioelastic polymers. Bioelasticity is imparted by structures that impart internal dampening of chain dynamics upon polymer extension, i.e. oscillation or freedom to rotate about torsional angles or bonds is dampened. The dampening results in reducing the degrees of freedom available in the extended state.

This β-turn-containing structure is described in the prior patents and patent applications cited above and need not be described again in detail. Considerable variations in the amino acids that are present at various locations in the repeating units is possible as long as the multiple β-turns with intervening suspended bridging segments are retained in order to preserve elasticity. Furthermore, it is possible to prepare polypeptides in which these monomeric units are interspersed throughout a larger polypeptide that contains peptide segments designed for other purposes. For example, rigid segments can be included to increase the modules of elasticity or segments having biological activity (such as chemotaxis or cell attachment) can be included for their biological activity. Although there appears to be no upper limit to the molecular weight of useful polymers of the invention except that imposed by the processes of making these polymers. Polymers containing up to about 250 pentamers have been synthesized from E. coli using recombinant DNA methods.

These bioelastomeric materials, which include the prototypic poly(Val¹-Pro²-Gly³-Val⁴-Gly⁵) (referred to herein as “poly(VPGVG)”) and poly(Val¹-Pro²-Gly³-Gly⁴) molecules as well as numerous analogues, when combined with water form viscoelastic phases which when cross-linked result in soft, compliant, elastomeric matrices (1-3). The VPGVG-based polypentapeptide (and other bioelastomers) has been shown to be biocompatible both before and after cross-linking (4). As implants, such bioelastic polymers are biodegradable, leading to the release of products natural to the body, such as short peptide chains and free amino acids. These polymers, also referred to as elastomeric polypeptide biomaterials or simply bioelastic materials, can be prepared with widely different water compositions, with a wide range of hydrophobicities, with almost any desired shape and porosity, and with a variable degree of cross-linking by selecting different amino acids for the different positions of the monomeric units and by varying the cross-linking process, e.g. chemical, enzymatic, irradiative, used to form the final product. U.S. Pat. No. 4,589,882, incorporated herein by reference, teaches enzymatic cross-linking by synthesizing block polymers having enzymatically cross-linkable units.

Poly(VPGVG), exhibits an inverse temperature transition (24, 25) in which the polypentapeptide folds and assembles into more ordered structures on raising the temperature with formation of a more dense phase, called the coacervate phase (26-28). A working model for the folded molecular structure called a dynamic β-spiral and the supercoiling assembly of several β-spirals to form a twisted filament has been developed based on a wide range of physical and computational methods (24). On γ-irradiation cross-linking an insoluble elastic matrix is formed wherein, on raising the temperature, the molecular folding and assembly is seen as a macroscopic shrinking and extrusion of water from the matrix. As this thermally driven contraction can be used reversibly to lift weights, the matrix expresses its thermally driven folding as a reversible thermomechanical transduction (24). The temperature at which the folding and assembly occur can be shifted and thus folding and assembly can occur without a change in temperature. This is referred to as the ΔTₜ mechanism (32).

The temperature at which folding and assembly occur can be changed by changing a number of intrinsic or extrinsic changes. The chemical changes that can change the value of Tₜ may be grouped as intrinsic and extrinsic. Intrinsic to a class of model proteins of 50,000 Da molecular weight or greater are: (a) the concentration of polymer itself, (b) changes in the amino acid composition within the polymeric bioelastic unit, (c) changes in the degree of ionization of functional side chains controlled by changes in pH, (d) the phosphorylation of side chains such as serine by enzymes called kinases, (e) the oxidation or reduction electrically, chemically or enzymatically of a side chain attached to the polymer, and (f) chemical reactions of side chains in response to electromagnetic radiation.

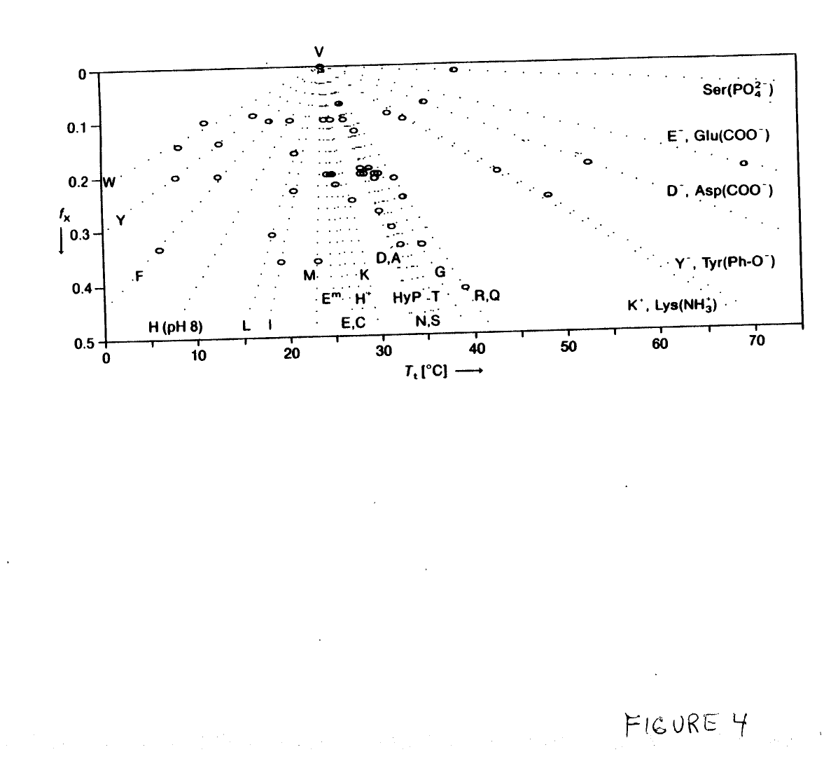

With awareness of the concentration effect and of certain conformational restrictions, the effect of changing the amino acid composition on the value of Tₜ can be determined. See FIG. 4. The result is a hydrophobicity scale based for the first time directly on the hydrophobic folding and assembly process of interest. This can be demonstrated using the polypentapeptide poly[ƒv(VPGVG),ƒₓ(VPGXG)], as an example, where ƒv and ƒx are mole fractions with ƒx+ƒv=1 and where X is any of the naturally occurring amino acid residues or chemical modifications thereof, and Tₜ is defined as the temperature for half-maximal turbidity. As seen by plotting ƒx versus Tₜ in FIG. 4 for all of the naturally occurring amino acid residues, more hydrophobic residues than Val, such as Ile(I), Phe(F), etc., lower the temperature of the transition whereas less hydrophobic residues like Ala(A), Gly(G) and polar residues like Asp(COO—)(D⁻), Lys(NH₃⁺)(K⁺), etc. raise the temperature of the transition (i.e., raise the value of Tₜ). The plots are essentially linear. Therefore, on extrapolating the linear plots to ƒx=1, values of Tₜ are obtained that give an index of relative hydrophobicity (34 and 44, which are both incorporated herein by reference). These values are given in Table 1.

The Tₜ-based hydrophobicity scale depicted in Table 1 is useful for protein engineering of bioelastic polymers of the invention. When a functional side chain or sequence is introduced, for example, to achieve a given free energy transduction, then residue X may be varied to place the value of Tₜ as desired for the intended protein function. When a given hydrophobic side chain in the repeating pentamer of a protein polymer is replaced by one having an additional hydrophobic CH₂ moiety, the value of Tₜ, the temperature of the inverse temperature transition, is lowered in direct proportion to the number of added CH₂ moieties. When a given hydrophobic side chain in the protein polymer is replaced by one having fewer CH₂ moieties, as when Val is replaced by Ala, the value of Tₜ is raised in direct proportion to the number of CH₂ moieties removed. Thus the value of Tₜ is clearly related to the hydrophobicity with lower values of Tₜ indicating greater hydrophobicity and higher values of Tₜ indicative of more polar or less hydrophobic residues.

TABLE 1
Temperature of the inverse temperature transition, Tₜ for
poly[fv(VPGVP)fx(VPGXG)]. Tₜ values are linearly extrapolated to fx = 1.

| | | Correlation |
|---|---|---|
| Amino acid residue X | Tₜ [° C.] | coefficient |
| Lys (NMeN, red.) [a] | −130 | 1.000 |
| Trp (W) | −90 | 0.993 |
| Tyr (Y) | −55 | 0.999 |
| Phe (F) | −30 | 0.999 |
| His (pH 8) (H) | −10 | 1.000 |
| Pro (F) | (−8) | [b] |
| Leu (L) | 5 | 0.999 |
| Ile (I) | 10 | 0.999 |
| Met (M) | 20 | 0.996 |
| Val (V) | 24 | [c] |
| Glu (COOCH₃) (E^{m}) | 25 | 1.000 |
| Glu (COOH) (E) | 30 | 1.000 |
| Cys (C) | 30 | 1.000 |
| His (pH 4) (H⁺) | 30 | 1.000 |
| Lys (NH₂) (K) | 35 | 0.936 |
| Asp (COOH) (D) | 45 | 0.994 |
| Ala (A) | 45 | 0.997 |
| HyP | 50 | 0.998 |
| Asn (N) | 50 | 0.997 |
| Ser (S) | 50 | 0.997 |
| Thr (T) | 50 | 0.999 |
| Gly (G) | 55 | 0.999 |
| Arg (R) | 60 | 1.000 |
| Gln (Q) | 60 | 0.999 |
| Lys (NH₃⁺) (K⁺) | 120 | 0.999 |
| Tyr (θ-O⁻) (Y⁻) | 120 | 0.996 |
| Lys (NMeN, ox.) [a] | 120 | 1.000 |
| Asp (COO⁻) (D⁻) | 170 | 0.999 |
| Glu (COO⁻) (E⁻) | 250 | 1.000 |
| Ser (PO₄⁻) | 1000 | 1.000 |

[a] NMeN represents N-methylnicotinamide pendant on a lysyl side chain, i.e., N-methylnicotinate attached by amide linkage to the ε-NH₂ of lysine. The reduced state is N-methyl-1,6-dihydronicotinamide residue.
[b] Calculated.
[c] Serves as reference substance.

Extrinsic chemical changes affecting Tₜ include the effects of salts, organic solutes and pressure. U.S. Pat. No. 5,226,292 from the laboratory of the present inventors details pressure-related effects. In addition there is a chain length dependence that becomes significant at lower molecular weights where shorter chain lengths result in higher values of Tₜ.

The chemical equivalent, of raising the temperature to achieve ordering in these molecular systems that exhibit inverse temperature transitions, is chemically lowering the transition temperature, Tₜ, at which the folding occurs. By making the polymer more hydrophobic, e.g., Val¹→Ile¹, the transition temperature is lowered; or by making it more hydrophilic, e.g., Val⁴→Ala⁴ or even Val⁴→Glu⁴COOH→Glu⁴COO⁻, the transition temperature (Tₜ) for coacervate phase formation, is raised. For poly[4(VPGVG),1(VPGEG)] where E=Glu, which is equivalent to poly[0.8(VPGVG), 0.2(VPGEG)], it becomes possible in phosphate buffered saline to shift the transition temperature for folding and phase separation from about 20° C. for COOH to about 70° C. for COO⁻, and at the isothermal condition of 37° C. the cross-linked matrix reversibly relaxes on raising the pH to about 7 and contracts on lowering the pH to about 3 (46). In doing so, weights can be lifted; this is chemomechanical transduction. Specifically, (δμ/δƒ)ₙ₌ₓ<0 where μ is chemical potential, ƒ is force and n=x indicates constant composition, i.e., in this case a constant degree of ionization (44). The efficiency of this mechanism of chemomechanical transduction appears to be an order of magnitude greater than that mechanism driven by charge-charge repulsion where (δμ/δƒ)ₙ>0, for example in polymethacrylic acid gels (36). If one recognizes that each chemically induced conformational change to achieve function involves chemomechanical transduction, then it is to be anticipated that proteins utilize this mechanism whenever it is available to achieve chemically induced function. In polymers such as poly(N-isopropylacrylamide) (45) inverse temperature transitions referred to as lower critical solution temperatures (LCST) were observed that were dependent on the content of hydrophobic isopropyl groups in the polymer. A ΔTₜ type of mechanism was not recognized perhaps because of more-limited control of composition in such polymers prevented the testing for such a model.

The preceding may be called polymer-based chemomechanical transduction. It is also possible to change the temperature of the inverse temperature, Tₜ, chemically by changing the extrinsic variable, the solvent composition, and this may be called solvent-based mechanochemical coupling or chemomechanical transduction. Indeed, a small increase in salt (NaCl) concentration can lower the value of Tₜ and this change can be used to drive chemomechanical transduction (20). Also, deuterium oxide lowers Tₜ; ethylene glycol lowers Tₜ (47); and urea raises Tₜ. All of these and many other solutes that change the value of Tₜ can be used to drive chemomechanical transduction.

Phenomenologically, chemomechanical transduction, as exemplified by poly(VPGVG) and its analogs, results from chemical modulation of the temperature of inverse temperature transitions. More descriptively, it is viewed as chemical modulation of the expression of hydrophobicity with both polymer-based and solvent-based means of altering hydrophobic expression. For polymer-based mechanochemical coupling, the driving force appears to arise from structurally-constrained and sufficiently proximal hydrophobic and polar moieties each competing for their uniquely required hydration structures. In other words, there occurs an apolar-polar interaction free energy of hydration which is generally repulsive due, for example, to a polar species achieving improved structuring of hydration shells by destructuring the clathrate-like (caged) water of hydrophobic moieties or conversely, when the cluster of hydrophobic residues becomes more dominant in achieving its cages of water, by limiting the hydration required by the more polar species. This allows that increasing hydrophobicity can cause an increase in carboxyl pKₐ by raising the free energy of the more polar species due to inadequate hydration (25). For solvent-based mechanochemical coupling, solutes added to the water solvent interfere with the waters of hydrophobic hydration either by decreasing the activity of water or by directly altering the clathrate-like cage of water.

In U.S. Pat. No. 5,226,292, (incorporated herein by reference) the present inventor demonstrated that incorporation of relatively large hydrophobic side chains in monomeric polypeptide units produced a previously unrecognized property in the resulting overall polymer, namely a sensitivity of the inverse temperature transition of the polymer to external pressure. This property is not strictly related to hydrophobicity, as were many prior properties, but required the presence of large hydrophobic side chains. Here “large” means preferably larger in volume than an isopropyl group; i.e., larger than 20 cm³/mole. Even larger hydrophobic groups are preferred (e.g., 100, 500, 1000, or even higher volumes as expressed in cm³/mole). The hydrophobic groups are selected to be sufficiently large and to be present in sufficient extent to provide PdV/dS of at least 0.2° K., preferably at least 1° K., more preferably at least 5° K., and most preferably at least 20° K. (where P=pressure, V=volume, and S=entropy). The patent further provides a method for experimentally determining PdV/dS values. Either increasing the size of hydrophobicity of the hydrophobic groups present or increasing their amount (usually expressed as a mole fraction) in a polymer increases the PdV/dS value. However, knowledge of the exact PdV/dS value for a particular polymer was not required in order carry out the invention, and estimates of whether any given polymer will be likely to have a desirable baromechanical or barochemical response were readily made by comparison of the amount and type of hydrophobic groups present in a particular polymer. There are no particular upper limits on the size or amount of hydrophobic groups in a polymer of the invention or on the hydrophobicity of the particular substituent as long as the resulting polymer undergoes an inverse temperature transition and has the stated PdV/dS value. These properties and methods apply when designing polypeptides of the present invention which are capable of transducing light energy.

The instant application reports the effects of light energy on Tₜ for protein and protein-based bioelastic polymers, particularly of the poly(VPGVG) type and its analogs or co-polymers, and describes how to use these systems to exhibit light energy coupled transduction to produce useful work. A model complex polymer poly [0.5(VPGVG, 0.5(VPGXG)] (referred to herein as copolypeptide II), where X is a glutamic acid residue substituted at its -carboxyl group through an amide link to photoreactive azobenzene, was synthesized and studied. Modulation of the polymer's inverse temperature transition by irradiation was monitored by observing phase separation as detected by changes in sample turbidity.

The invention will be described initially using the polymer system that was originally helpful in determining the broader aspects of the invention that are later described herein. However, it will be recognized that this initial description is not limiting of the invention, as these examples can readily be modified using the later-described techniques to provide numerous compositions that have the properties discussed herein and which can be used in the methods and apparatuses described herein.

The first protein polymer system showing photomechanical properties described herein used elastic protein-based polymers of the formula poly[ƒx(VPGXG),ƒv(VPGVG)] where ƒv and ƒx are mole fractions with ƒx+ƒv=1, and X is an amino acid residue having a side chain responsive changes in exposure to light energy. As described above, these bioelastomers exhibit inverse temperature transitions in the form of a phase separation in which folding and aggregation of water-soluble polymer chains into more-ordered states of the condensed (coacervate) phase occur on raising the temperature. This inverse temperature transition, while uncommon in the universe of polymers, is common to the bioelastomers described herein and can readily be detected in other polymers by the simple solution/heating scheme described above. Investigations into the polymers of the formula immediately above in which X is 50% glutamic acid and 50% azobenzene derivative of glutamic acid (see Formula II of Example 1 below), showed that a change in exposure to the wavelength of light caused a substantial increase in the temperature of the transition such that an application of light of one wavelength when the polymer is above the transition temperature leads to isomerization of the azobenzene moiety to a relatively more hydrophobic trans form. The isomerization leads to hydrophobic hydration, unfolding and dis-aggregation of the polymer, such that the volume of the coacervate phase (or of a cross-linked matrix) increases on exposure to light that induces the trans form.

The transition temperature is usually selected to be within 20° C. of the temperature of the medium being exposed in order to allow light energy induced effects to occur within a reasonable change in light energy. By providing Tₜ closer to the medium temperature (e.g., less than 10° C., preferably less than 5° C., more preferably less than 2° C.), the system is made more sensitive to changes in light energy. Although the inventors do not intend to be limited by the theory of how this expansion takes place, it is believed that water molecules surrounding the hydrophobic side chains of the isomerizing moiety occupy less volume than water molecules in bulk water surrounding the polymer. The capacity to achieve useful mechanical work by polymers of the invention is further illustrated by the calculated volume change for a polymer poly[0.8(GVGVP),0.2(GFGVP)], for example, on going from coacervate phase where hydrophobic associations have largely eliminated waters of hydrophobic hydration to dispersed in water where the hydrophobic moieties are surrounded by water is 80 cm³/mole of mean pentamers, or some 400 cm³/mole of (GFGVP). By incorporating photoresponsive groups that have a similar degree of change in hydrophobicity upon light energy exposure, materials exhibiting light energy coupled mechanical transduction can be similarly designed to achieve useful mechanical work.

It should be noted that the location of the “X” residue in the polymer as described above is not critical to achieving a photo-response and was made in these examples principally for ease of synthesis. Some variations in properties do occur with substitution of other amino acid residues in the pentameric elastomer unit. The specific location of a side chain in the polymer is not important as long as the bulk properties of the polymer are maintained. However, as taught herein, the magnitude and direction of the bioelastomers response to light energy is affected by the location, position, orientation, number, kind and size of the photoresponsive group and other amino acids in the bioelastic unit.

These results illustrate that attachment of one azobenzene chromophore in approximately forty amino acid residues is sufficient to render photosensitive the inverse temperature transition of polypeptides, and that isothermal reversible photomodulation of the transition, in this case at 40° C., can be achieved.

Light energy-responsive groups are selected to provide a sufficient change in hydrophobicity or polarity and to be present in sufficient extent to provide a shift in the reverse temperature transition of at least 0.2° C., preferably at least 1° C., more preferably at least 5° C., and most preferably at least 20° C. Either increasing the change in hydrophobicity or polarity of the reactive groups present or increasing their amount (usually expressed as a mole fraction) in a polymer increases the shift in the reverse temperature transition. As discussed the shift can be either a decrease or an increase in Tₜ. However, knowledge of the exact degree of shift for a particular polymer is not required in order carry out the invention, and estimates of whether any given polymer will be likely to have a desirable degree and direction of shift in Tₜ and transduction response is typically determined by comparison of the type and degree of hydrophobic/polar groups present in a particular polymer. There are no particular upper limits on the size or amount of reactive groups in a polymer of the invention or on the hydrophobicity or polarity of the particular photoresponsive substituent as long as the resulting polymer undergoes an inverse temperature transition of the given value. The ratio of photoresponsive groups to monomer residue can range from 1:2 to 1:5000. Preferably the ratio is 1:10 to 1:100. Generally, manufacturing is easier if water-soluble polymers (below the transition temperature) are used. Non-water soluble polymers can be manufactured using organic solvents that in most cases should be removed and replaced with water before use. The upper limit on the number and kind of substituents is also influenced by the ability of the elastic polymer to fold/assemble properly to attain a beta-spiral in the relaxed state. The location of the substituents in the polymer, with respect to the monomer residue side-chain position, is not critical so long as the beta-turn is not prevented from forming in the relaxed state. Preferred positions for the various peptides of the invention are as taught in the patents and pending applications from the laboratory of the present inventors in this area, which have been incorporated by reference.

The superiority of protein-based polymers over that of polymethacrylic acid is demonstrated by comparing efficiencies of achieving mechanical work. The charge-charge repulsion mechanism, represented by polymethacrylic acid, and the salt-dependent collapse of the collagen structure can be compared with the protein-based polymers. A measure of efficiency η can be the mechanical work achieved which is the force ƒ times the displacement, ΔL, divided by the chemical energy, ΔμΔn, expended in performing the work where Δμ is the change in chemical potential discussed above and Δn is the change in moles related to the intrinsic change. For example, Δn can be the number of moles of carboxylates (COO⁻) changed to carboxyls (COOH). The expression for efficiency therefore can be written as η=fΔL/ΔμΔn.

Polymethacrylic acid, [—CCH₃COOH—CH₂-—]ₙ, utilizes the same (COOH/COO⁻) chemical couple as the protein-based polymer, poly[0.8(VPGVG),0.2(VPGEG)]. Also, the cross-linked matrices of both can contract to about one-half their extended length and can lift weights that are a thousand times greater than their dry weight such that the numerators, ƒΔL are similar in magnitude (48-50). Where the difference occurs is in the chemical energy required to achieve that work.

For polymethacrylic acid, extension due to charge-charge repulsion is achieved when 50 to 60% of the carboxyl moieties are converted to COO⁻and the collapse of the extended state to achieve contraction occurs down to 0 to 10% ionization (48-50). Thus some 40 carboxylates must be protonated per 200 backbone atoms. For X²⁰-poly[0.8(VPGVG),0.2(VPGEG)], only 4 carboxylates per 300 backbone atoms need to be protonated. (“X₂₀” indicates that the polymer has been cross-linked with 20 Mrads of gamma radiation.) Thus, the Δn is more than 10 times larger for the polymethacrylic acid system. Also the change in chemical potential, Δμ, of proton required to achieve those changes in degree or % of ionization is greater for the charge-charge repulsion (polymethacrylic acid) case (51). The change in proton chemical potential to go from 50-60% ionized to 0-10% ionized is some 2 pH units for polymethacrylic acid because of the negative cooperativity of the titration curve (49,51). For the protein-based polymer, the titration curve exhibits positive cooperativity and only the change of a fraction of a pH unit achieves the required change in degree of ionization. The result is that conversion of chemical energy into mechanical work is greater than 10 times more efficient for the ΔTₜ-mechanism.

The calculation of comparative efficiencies is as follows. For η_{cc}, which is the efficiency of charge-charge repulsion mechanism as exemplified by polymethacrylic acid, the factors in the above equation for efficiency are w where ΔL≈0.5 and ƒ≈1000×dry weight, Δn is greater than 40 (COO—→COOH) per 200 backbone atoms, and Δμ≈2.8 kcal mol⁻¹ (Δα≈0.6→ΔpH≈2.0). For ηₐₚ, which is the efficiency of apolar-polar repulsion free energy mechanism as exemplified by X²⁰-poly[0.8(VPGVG),0.2(VPGEG)], for w ΔL≈0.5 and ƒ≈1000×dry weight, Δn is less than 4 (COO⁻→COOH) per 300 backbone atoms, and Δμ≈0.94 kcal mol⁻¹ (Δα≈0.8→ΔpH≈2.0). The calculated efficiency ratio (η_{cc}/ηₐₚ) is greater than 10.

A similar order of magnitude greater change in efficiency is observed for the salt-effected contractions of the polymer X²⁰-poly(VPGVG) compared to that of collagen. The complete contraction can readily be achieved on going from 0 to 1 N NaCl for X²⁰-poly(VPGVG) and even a change from 0 to 0.15 N NaCl can drive very effective contractions (12). In the collagen case, special salts are required, such as LiBr and NaSCN, and urea can be used. These solutes lower the temperature at which denaturation occurs. In the most characterized case, the use of LiBr, 0 or 0.3 N was the low concentration side and 11.25 N was the high concentration side. Again, over an order of magnitude greater change in chemical potential was required to drive contraction in the collagen model.

From an experimental evaluation of the entropies of the transition, ΔSₜ(=ΔHₜ/Tₜ,), the calculated changes in volume for the transition, ΔVₜ, can be obtained, taking into account the different relative heats for the transitions (43), L=ΔHₜ.

The experimental work demonstrates how light energy responsive inverse temperature transitions may be achieved in the bioelastic polypeptides of the invention. Light energy responsiveness is achieved by having side chain groups that are light energy responsive, i.e. a light energy induced change in the hydrophobicity or polarity of the side chain group occurs, and that participate in a folding/unfolding transition. One design is to have such side chain groups clustered in domains which come into association on folding or which become exposed in unfolding as in a conformational change in which hydrophobic residues are buried in one state and exposed in the other.

Taking these experimental results into consideration, bioelastomers can be rationally designed in order to achieve the desired light energy sensitive properties described herein. The teachings of this inventor's previous patents related to bioelastic polymers provides additional information to guide one in the rational design of bioelastomers of the invention when coupled with the teachings of the present specification. The following discussion describes general selection techniques for achieving the embodiments of the invention with a variety of different protein and protein-based bioelastomers.

Using the relative hydrophobicities of the light energy-sensitive side chains, it is possible to construct polymers which will exhibit inverse temperature transitions by a systematic, knowledge-based approach. This approach can be used with natural compounds where there is stereochemical regularity, as well as with entirely synthetic molecules, as in the Examples below. Embodiments of the invention can be obtained by making polymers having photoresponsive bioelastic units of the invention interspersed between segments of other biomacromolecules, such as proteins or peptides, nucleic acid, DNA, RNA, lipid, carbohydrates, or stereochemically regular polymers, e.g. poly β-hydroxy alkanoates. Biomacromolecules are chosen to impart additional features such as chemotaxis, cell targeting and adhesion, hydrolase sensitivity, elastic modulas, or drug attachment. Embodiments of the invention can be achieved with polymers that are degradable as well as with polymers that are not so degradable and also with polymers having greater thermal stability. The preferred polymers of the invention are protein and protein-based bioelastomers. Most preferred are those containing bioelastic pentapeptides, tetrapeptides, and nonapeptides.

The regularity of structure of the protein and protein-based photoresponsive polymers of the invention allows optimal arrangement of the structural components for which coupled effects are desired. For example, the photoresponsive side chain can be predictably positioned spatially with respect to the second side chain couple for optimal effect.

Preferred photoresponsive polymers are those which do not occur naturally in their basic form prior to inclusion of the photoresponsive group. Such polymers can be synthetic or recombinant based products. Naturally occurring polymers having an inverse temperature transition can be used as starting material for derivitization to contain photoresponsive side chains. Photoresponsive bioelastic units of the invention can be attached to or interspersed among other types of molecules, which compounds can impart functions to the polymer such as biological activity, chemotaxis, protease, or nuclease susceptibility. Such molecules include peptides, proteins, nucleic acid, DNA, RNA, carbohydrates and lipid chains.

The phenomena of inverse temperature transitions in aqueous systems occurs in a number of amphiphilic systems, commonly polymers, that have an appropriate balance and arrangement of apolar and polar moieties. The polar species contribute to the solubility in water at low temperature, a solubility that results in waters of hydrophobic hydration for the apolar moieties. The waters of hydrophobic hydration, often referred to as clathrate or clathrate-like water, have specific thermodynamic properties: an exothermic heat of hydration (a negative ΔH) and a negative entropy of hydration (6,7). On raising the temperature, by means of an endothermic transition (8), the low entropy waters of hydrophobic hydration become bulk water with a significant increase in solvent entropy as the polymers fold and aggregate, optimizing intra- and intermolecular contacts between hydrophobic (apolar) moieties with a somewhat lesser decrease in polymer entropy than increase in solvent entropy. Such polymers, when their transitions occur between 0° and 100° C., can be used to control events in the aqueous environments that occur in biology. However, transitions that occur at other temperatures can also be used in the practice of the present invention, since the addition of salt or organic solvent to aqueous systems or application of pressure on aqueous systems will cause water to remain liquid at temperature outside the normal liquid-water range. Since systems of the invention can operate under 100 atmospheres of pressure or more, the temperature range can be considerably extended. A preferred temperature range is that of liquid water, wherein there is sufficient bulk water to allow for changes in hydration of chemical groups on the polymer. An upper limit for temperature is the limit above which results irreversible polymer denaturation or racemization that results in a loss of structural regularity of the polymer, which in turn results in a loss of control of polymer activity and transduction efficiency. A lower limit for temperature is the limit below which undesirable effects such as solution solidification and disruptions in polymer structure and regularity occur. A preferred temperature range is from 0° C. to 100° C.

The polypentapeptide poly(Val¹-Pro²-Gly³-Val⁴-Gly⁵), also written poly(VPGVG), is a particularly well-balanced polymer for modification with light energy sensitive groups to provide biological utilities as its transition is just complete near 37° C. Below 25° C., it is miscible with water in all proportions where it exhibits a β-turn (see structural formula above) in which there occur hydrogen bonds between the Val¹-CO and the Val⁴-NH moieties (9). On raising the temperature, the polypentapeptide folds into a loose helix in which the dominant interturn hydrophobic contacts involve the Val¹-γCH₃ moieties in one turn and the Pro²-βCH₂ moiety in the adjacent turn (10). The loose helical structure is called a dynamic β-spiral and is proposed to be the basis for the entropic elastomeric force exhibited by this material once cross-linked (11). Concomitant with the folding is an assembly of β-spirals to form a twisted filament which optimizes intermolecular contacts.

When poly(VPGVG) is cross-linked, for example, by 20 Mrads of γ-irradiation, an elastomeric matrix is formed which is swollen below 25° C. but which on raising the temperature through the transition contracts with the extrusion of sufficient water to decrease the volume to one-tenth and to decrease the length of a strip of matrix to 45% of its swollen length (2). This thermally driven contraction can be used to lift weights that are one thousand times the dry weight of the matrix. This is called thermomechanical transduction. As will be discussed below, any chemical means of reversibly or irreversibly shifting the temperature of the transition can be used, isothermally, to achieve chemomechanical transduction.

The temperature of the inverse temperature transition of the substituted polypentapeptides described in the following Examples was used to develop a relative hydrophobicity scale as shown in FIG. 4, which contains the apolar side for natural and modified amino acid residues. Introduction of a polar side having protonated/deprotonated chemical couples gives rise to polymer-based chemomechanical transduction. Values for the degree in the shift of Tₜ are provided for in Table 1 for model side chain groups. The degree of shift in Tₜ for a coupled light energy induced reaction of an light energy responsive side chain group, such as isomerization (e.g. cis to trans), protonation/deprotonation, ionization/deionization, can be determined empirically as taught herein or by using FIG. 4 and Table 1 as a guideline base on the known hydrophobicity or polarity of both states of the light energy responsive side chain. The coupled reaction can be irreversible, such as in addition or dimerization reactions.

A description of the process of designing bioelastomers specifically to provide an inverse temperature transition at any temperature from 0° C. to 100° C. is described below in detail. The specific examples used below to illustrate this process are mostly examples of elastomeric polypentapeptide matrices. However, it will be apparent that the same considerations can be applied to elastomeric tetrapeptide and nonapeptide matrices and to matrices prepared using these elastomeric units in combination with other polypeptide units as described previously for bioelastic materials.

The temperature of inverse temperature transitions can be changed by changing the hydrophobicity of the polymer. For example, make the polypeptide more hydrophobic, as with poly(Ile¹-Pro²-Gly³-Val⁴-Gly⁵), where replacing Val¹ by Ile¹ represents the addition of one CH₂ moiety per pentamer, and the temperature of the transition decreases by 20° C. from 30° C. for poly(VPGVG) to 10° C. for poly(IPGVG) (1). Similarly, decreasing the hydrophobicity as by replacing Val⁴ by Ala⁴, i.e., removing the two CH₂ moieties per pentamer, and the temperature of the transition is raised by some 40° C. to 70° C.

A major advantage of the bioelastic polypeptides of the invention is the extent to which fine-tuning of the degree of hydrophobicity/polarity and resulting shift in the inverse temperature transition can be achieved. For example, in Example 1 the photoreactive group is attached to the peptide backbone through the gamma carboxyl group of glutamic acid; however, a decrease in the overall hydrophobicity can be obtained by attachment of the photosensitive group through the gamma carboxyl group of aspartic acid, which is a shorter homolog of glutamic acid. This replacement is analogous to the replacement of Val by Ala discussed above for protein polymers, and further demonstrates that, in view of the present invention, design concepts previously identified for selecting _{Tt} for other bioelastic polymers applies to the design of light energy-reactive bioelastic polymers of the present invention.

Many known compounds are reactive to changes in exposure to light energy, particularly of the visible, ultraviolet or infrared spectra, with well-known reaction products, from which to choose in designing bioelastic polymers of the invention. Coupled with the ease of synthesis of peptide units, for example by solid phase peptide synthesis methods, the present specification now provides one skilled in the art with the tools and guidance to rationally design a diverse array of light energy-sensitive bioelastic polymers of the invention.

The regularity of structure of the protein and protein-based photoresponsive polymers of the invention allows optimal arrangement of the structural components for which coupled effects are desired. For example, the photoresponsive side chain can be predictably positioned spatially with respect to the second side chain couple for optimal effect.

Optimal spatial proximity can be achieved by placing residues adjacent to each other in the backbone (i.e., based on primary sequence) and also by positioning to provide inter-turn proximity. As taught herein, the effect of positioning can be determined both theoretically, based on known structures of model polymers, and empirically as exemplified herein and in the references incorporated herein.

In terms of a generalized hydrophobicity scale, the COOH moiety is more hydrophobic than the COO⁻ moiety. The transition temperature can be lowered simply by decreasing the pH and raised by increasing the pH of the medium contacting a bioelastomer when a carboxylate group is present (or other group capable of forming an ion upon increasing the pH). If an intermediate temperature is maintained, then a 20 Mrad cross-linked matrix of poly[4(VPGVG), 1(VPGEG)], that is, a random copolymer in which the two pentameric monomers are present in a 4:1 ratio, where E=Glu, will contract on lowering the pH and relax or swell on raising the pH (12). The temperature of the transition in phosphate buffered saline will shift some 50° C. from about 20° C. at low pH, giving COOH, to nearly 70° C. at neutral pH where all the carboxyls have been converted to carboxylate anions. By choosing a side chain group whose protonation/deprotonation can be light energy modulated one can in turn modulate the response of the polymer to changes in pH. In addition, the degree of contraction or expansion in response to light energy by the polymer containing bioelastic units having a light energy responsive protonizable/deprotonizable group can be modulated by the particular pH of the medium.

For similarly cross-linked poly[4(IPGVG),1(IPGEG)], the temperature of the inverse temperature transition shifts from near 10° C. for COOH to over 50° C. for COOR⁻ (5). For this more hydrophobic polypentapeptide, which contains 4 Glu residues per 100 total amino acid residues, it takes twice as many carboxylate anions to shift the transition to 40° C. as for the less hydrophobic polypentapeptide based on the VPGVG monomer. Thus, it is possible to change the conditions of the transition by varying the hydrophobicity of the region surrounding the group that undergoes the chemical change. Since contraction and relaxation of the bulk polymer is dependent on the sum of all local thermodynamic states, sufficient control is possible merely by controlling the average environment of, for example, ionizable groups, such as by changing the percentage of monomers present in a random (or organized) copolymer.

When the pH is lowered (that is, on raising the chemical potential, m, of the protons present) at the isothermal condition of 37° C., these matrices can exert forces, ƒ, sufficient to lift weights that are a thousand times their dry weight. This is chemomechanical transduction, also called mechanochemical coupling. The mechanism by which this occurs is called an hydration-mediated apolar-polar repulsion free energy and is characterized by the equation (δμ/δƒ)ₙ<0; that is, the change in chemical potential with respect to force at constant matrix composition is a negative quantity (13). Such matrices take up protons on stretching, i.e., stretching exposes more hydrophobic groups to water which makes the COO⁻ moieties energetically less favored. This is quite distinct from the charge-charge repulsion mechanism for mechanochemical coupling of the type where (δμ/δƒ)ₙ>0 and where stretching of such matrices causes the release of protons. The hydration-mediated apolar-polar repulsion mechanism appears to be an order of magnitude more efficient in converting chemical work into mechanical work.

It may be emphasized here that any chemical means of changing the mean hydrophobicity of the polymer, such as an acid-base titratible function, dephosphorylation/phosphorylation, reduction/oxidation of a redox couple, etc., can be used to bring about contraction/relaxation. At least one of the coupled reactions states of the photoresponsive side chain will be achieved upon a change in exposure to light energy. Fine tuning of the transitions can be achieved by employing the hydrophobicity or induced chemical changes on the side chains of certain amino acids, preferably one of the 20 genetically encoded amino acids or a derivative thereof. Examples of light energy induced reactions of side chain groups include ionization, deionization, oxidation, reduction, amidation, deamidation, isomerization, dimerization, hydrolysis, and addition.

Fine-tuning of the degree of contraction/expansion as well as transduction to non-mechanical free energies can be achieved by the addition of non-light energy-reactive groups to the bioelastic polymers of the invention. Such polymers are embodiments of the present invention. Furthermore, amino acid monomer units are readily modified to further expand the set of available reactions for fine-tuning. For example, a sulfate ester of Ser can be added in which sulfate ionizations will occur at a pH outside the range experienced by carboxylate groups. A change in the oxidation state of NAD, a flavin, or a quinone attached to an amino acid by reaction of a functional group in the modifying moiety and a functional group in an amino acid side chain is also effective. A specific example of such a modified amino acid residue is a riboflavin attached to the carboxylate group of a Glu or Asp residue through formation of an ester linkage. Another example would be a heme moiety covalently bonded to the side chain of an amino acid. For example, protoporphyrin IX can be attached to the amino group of Lys through one of its own carboxylate groups. Heme A (from the cytochromes of class A) could be attached in a similar manner. Change in the oxidation state of, or coordination of a ligand with, the iron atom in a heme attached to an amino acid side chain can also be used to trigger the desired transition. To achieve light energy modulated effects, one will choose light energy-reactive side chain groups that are sensitive to environmental changes in similar fashion as those discussed above.

As discussed, light energy induced reactions can change the hydrophobicity or polarity of a light energy-reactive side chain or chromophore attached to an amino acid side chain. As the photoproducts can be quite varied, reactions are available to one rationally designing polymers of the invention so that either a lowering of the value of Tₜ or an increase in the value of Tₜ can be obtained. For example, photoreduction of nicotinamide dramatically lowers the value of Tₜ leading to light-driven folding. Photochemical reaction of a spiropyran attached by ester linkage to a glutamic acid residue of a copolymer decreases the value of Tₜ, whereas the photochemical reaction of an attached cinnamic acid moiety causes a dark reversible increase in Tₜ.

As taught herein polypeptides or proteins with the correct balance of apolar (hydrophobic) and polar moieties become more-ordered on raising the temperature because of hydrophobic folding and assembly. This process is called an inverse temperature transition. For some of the polypeptides the inverse temperature transition is a reversible phase transition with the formation of a more-dense, polypeptide-rich, viscoelastic phase on raising the temperature. When the viscoelastic phase is cross-linked, elastic matrices are formed which, on raising the temperature through the temperature range of the inverse temperature transition, contract and in doing so lift weights that can be a thousand times the dry weight of the matrix. These matrices can perform useful mechanical work on raising the temperature. Such elastic matrices are referred to as zero order molecular machines of the inverse temperature transition (Tₜ) type.

It is possible, without a change in temperature, to drive the inverse temperature transition of hydrophobic folding and assembly by each energy source that can lower the value of Tₜ, that is, to lower the temperature range over which the inverse temperature transition occurs. Four different energy sources have been found to change the value of Tₜ. Stated in terms of free energy transductions, these are chemomechanical, baromechanical, electromechanical and photomechanical transduction. With a polymer having an attached side chain group that can be reduced or oxidized either chemically or by means of an electrical potential, a chemical change can markedly change the value of Tₜ. In a similar manner, the presence of a chromophore, which on absorption of light produces a long-lived change in the polarity of the chromophore, can change the value of Tₜ. This general process is called the ΔTₜ-mechanism of free energy transduction. Each of these energy inputs can reversibly drive hydrophobic folding or unfolding, as the case may be, with the performance of useful mechanical motion. As such the designed proteins are molecular engines, and they may also be called first-order molecular machines of the Tₜ-type. FIG. 8 depicts first-order energy type transductions as those that entail all of the pairwise energy conversions involving the mechanical apex.

Changing the composition of the protein-based polymer systematically changes the transition temperature. Furthermore, the intrinsic chemical change of changing the degree of ionization of a functional side chain in the polypeptide also changes the temperature at which the inverse temperature transition occurs, which is equivalent to changing composition without synthesis of a new polymer. The cross-linked viscoelastic phase of such a polypeptide isothermally exhibit a pH-driven contraction capable of doing useful mechanical work. In general, such an elastic matrix, in which chemical energy or any other energy source can change the temperature at which the inverse temperature transition occurs and can thereby be caused to contract and perform useful mechanical work, is called a first order molecular machine of the Tₜ type. The work performed is the direct result of hydrophobic folding and assembly. The Tₜ-type first order energy conversions are those coupled to mechanical work.

Any energy input that changes the temperature, Tₜ, at which an inverse temperature transition occurs can be used to produce motion and perform mechanical work. Chemically-driven hydrophobic folding can result in motion and the performance of mechanical work, i.e., chemomechanical transduction. Electrochemically driven, pressure release-driven, and photo-driven hydrophobic folding result in electromechanical, baromechanical, and photomechanical transductions, respectively. Bioelastic polymers capable of transducing these energies are examples of first-order molecular machines of the Tₜ-type.

Photomechanical transduction is achieved using polymers of the invention that have a preferred photoresponsive moiety, spiropyran and its derivatives. The photochemical reaction of spiropyran, when attached for example by an ester linkage to a glutamic acid residue in a bioelastomer, results in a decrease in Tₜ that results in a change in the folding of the bioelastomer to achieve a photomechanical transduction. Photomechanical transduction by a bioelastic polymer of the invention is further exemplified by the photoreduction of an attached nicotinamide.

Different energy inputs, each of which can individually drive hydrophobic folding to produce motion and the performance of mechanical work, can be converted one into the other (transduced) by means of the inverse temperature transition with the correctly designed coupling and Tₜ value, as taught herein. Electrically (reduction) driven hydrophobic folding can result in the performance of chemical work, e.g. the uptake (or release) of protons, i.e., electrochemical transduction. Controlled hydrophobic folding results in additional transductions: electrothermal, baroelectrical, photovoltaic, thermochemical, photothermal, barothermal, barochemical, photobaric, and photochemical. Bioelastic polymers of the invention capable of photovoltaic, photothermal, photobaric, and photochemical transductions are examples of second-order molecular machines of the Tₜ-type.

In addition to mechanical coupled transduction, bioelastic polymers capable of Tₜ-type second order energy conversions such as photochemical, photovoltaic, photothermal, and photobaric, are now possible in light of the teachings of the present specification. Second order energy conversions of the Tₜ-type are those not coupled directly to mechanical energy, for example, photochemical transduction as taught herein, or barochemical transduction as taught in U.S. Pat. No. 5,226,292. Though these transductions utilize the hydrophobic folding and assembly capacity of the elastic matrix, mechanical work is not one of the pair of energies being interconverted. As a further example of a Tₜ-type second order energy conversion, consider a swollen matrix of unfolded polypeptides containing both an oxidized component of a redox couple, e.g., N-methyl nicotinamide, and the charged moiety of a chemical couple, e.g. (COO⁻), with the composition of the protein-based polymer such that Tₜ is just above the operating temperature. Under these circumstances, either lowering the pH to convert the COO⁻ to COOH or the reduction of the nicotinamide, the oxidized prosthetic group (redox couple), would lead to hydrophobic folding and assembly. If the oxidized prosthetic group were reduced, then the resulting folding would be expected to shift the pKa of the carboxyl moiety, and under the proper conditions the chemical result would be an uptake of protons (a decrease in proton chemical potential). If, on the other hand, the pH were lowered and the carboxylate anion were protonated, then the electrochemical potential of the oxidized prosthetic group would be expected to shift in favor of reduction and the electrical result could be the uptake of electrons. Either of these scenarios are designated as electrochemical transduction. Both utilize hydrophobic folding, but the energy produced or the work performed is not mechanical in nature. The elastic matrix so designed to achieve electrochemical transduction is in our designation a second order molecular machine of the Tₜ₋type. In the above examples if the redox group was a side chain that upon a change in exposure to light energy underwent reduction, the resulting change would lead to folding and assembly of the bioelastic polymer, which in turn would lead to a shift in the pKa of the carboxyl moiety that, under the proper conditions, would result in an uptake of protons. This is but one example of a photochemical transduction. One skilled in the art can now rationally design bioelastic polymers that undergo light energy coupled second order transductions of the Tₜ-type.

Depending on the work, type of transduction, or polymer activity desired, the type of couple for a second side chain couple includes ionization/deionization, oxidation/reduction, protonation/deprotonation, cleavage/ligation, phosphorylation/dephosphorylation, amidation/deamidation, etc., a conformational or a configurational change, e.g. cis-trans isomerization, an electrochemical change, e.g. pKa shift, emission/absorbance, or other physical change, e.g. heat energy radiation/absorbance. A preferred change that takes place in an aqueous environment is a chemical change. A preferred chemical change is a pKa shift. As depicted in FIG. 8, second-order type free energy conversion are those ten pairwise energy conversions which do not involve the mechanical force apex. These energy conversions utilize the inverse temperature transitions, that is, the hydrophobic folding and assembly transitions, but they do not require the production of useful mechanical motion. These energy conversions (exclusive of thermomechanical transduction) include among others those energy inputs which drive hydrophobic folding or unfolding to result in the uptake or release of heat as when the arrow ends at the thermal apex of FIG. 8. They can include changes in the states of coupled functional moieties as when the arrow ends at the chemical, electrical, pressure or electromagnetic radiation apices. Photoresponsive polymers of the invention that transduce energy utilizing the inverse temperature transition but do not directly produce motion from the folding are referred to as second-order molecular machines of the Tₜ-type where again Tₜ is to indicate the use of the inverse temperature transition as the mechanism for transduction.

An example of a photochemical transduction occurs when, for instance, a photooxidation or photoreduction reaction of a photoresponsive side chain group attached to a bioelastic polymer produces a change in chemical energy seen as the release or uptake of a proton from a second side chain functional moiety, e.g. an ammonium or carboxylate moiety. If the photoreaction is a reduction which lowers Tₜ and drives hydrophobic folding, then a suitably coupled carboxylate moiety will have its pKa raised such that it can take up a proton to become part of the hydrophobically folded structure.

As an example, the composition of the bioelastic polymer of the invention capable of photochemical transduction can be of the formula, or contain a segment of the formula, poly[fₓ(VPGXG),fᵥ(VPGVG),f_{z}(VPGZG)] where fₓ, fᵥ, and fᵥ are mole fractions with fₓ+fᵥ+f_{z}=1, X represents the light energy-reactive amino acid residue, and Z represents an amino acid residue having a side chain capable of undergoing reversible chemical change in an aqueous environment.

The bioelastic polymer of Example 3, where the change in cinnamic acid is coupled to the pKa shift in aspartic acid, exemplifies a photochemical energy transduction. A photoelectrical energy transduction is exemplified by a photoreduction reaction in which the electrical potential of the polymer is changed in response to light energy. Such pairwise energy conversions do not involve useful mechanical motion.

It is also possible to exert fine control over the transition from a relaxed to a contracted state (or vice versa) by controlling the average environment in which the various functional groups undergoing transition are located. For example, the hydrophobicity of the overall polymer (and therefore the average hydrophobicity of functional groups present in the polymer) can be modified by changing the ratio of different types of monomeric unit, as previously exemplified. These can be monomeric units containing the functional group undergoing the transition or other monomeric units present in the polymer. For example, if the basic monomeric unit is VPGVG and the unit undergoing transition is VPGXG, where X is a amino acid reside modified to have a photoreactive side chain, either the ratio of VPGVG unit to VPGXG units can be varied or a different structural unit, such as IPGVG, can be included in varied amounts until the appropriate transitions temperature is achieved.

In general, selection of the sequence of amino acids in a particular monomeric unit and selection of the required proportion of monomeric units can be accomplished by an empirical process that begins with determining (or looking up) the properties of known bioelastomers, making similar but different bioelastomers using the guidance provided in this specification, and measuring the transition temperature as described herein and in the cited patents and patent applications. Preferably, however, one uses tables of relative hydrophobicity of amino acid residues (either naturally occurring or modified) to compute the transition temperature without experimentation. For example, see Y. Nozaki and C. Tanford, J. Biol. Chem. (1971) 246:2211-2217, or H. B. Bull and K. Breese, Archives Biochem. Biophys. (1974) 161:665-670, for particularly useful compilations of hydrophobicity data. For example, a rough estimate can be obtained of the likely transition temperature by summing the mean hydrophobicities of the individual amino acid residues, or their side chain modified forms, in the monomeric units of the polymer and comparing the result to the sum obtained for polymers having known transition temperatures.

More accurate values can be calculated for any given polymer by measuring transition temperatures for a series of related polymers in which only one component is varied. For example, polymers that mostly contain VPGVG monomers with varying amounts of VPGXG monomers (e.g., 2%, 4%, and 8% X) can be prepared and tested for transition temperatures. The test merely consists of preparing the polymer in uncrosslinked form, dissolving the polymer in water, and raising the temperature of the solution until turbidity appears, which indicates the precipitation of polymer from solution. If the transition temperatures are plotted versus the fraction of VPGXG monomer in the polymer, a straight line is obtained, and the fraction of VPGXG necessary for any other desired temperature (within the limits indicated by 0% to 100% of the VPGXG monomer) can be obtained directly from the graph. When this technique is combined with the rough estimating ability of hydrophobicity summing as described above, any desired transition temperature in the range of liquid water can be obtained.

Bioelastomeric materials provide a chemically modulable polymer system as part of which there can be a controlled rate of presentation of more polar species such as the carboxylate anion. By the mechanism described above where (δμ/δƒ)ₙ<0, the pKa of a carboxyl moiety in a polymeric chain can be increased by increasingly vicinal hydrophobicity (13,15).

As noted above, hydrophobic hydration is an exothermic process. Accordingly, the reverse process of the inverse temperature transition, which involves the destruction of the waters of hydrophobic hydration in order for hydrophobic association to occur, is an endothermic process. Using the same elastic protein, poly[0.8(VPGVG),0.2(VPGEG)], as used in the stretch experiment discussed above, the endothermic heat of the inverse temperature transition is approximately 1 kcal/mole of pentamers at low pH where all of the Glu(E) side chains are COOH. When the pH is raised to 4.5 where there are approximately two COO⁻ moieties per 100 residues, and less than a 20° C. increase in the value of Tₜ, the endothermic heat of the transition has been reduced to almost one-fourth. It appears that nearly three-fourths of the thermodynamically measurable water of hydrophobic hydration has been destructured during the formation of two COO⁻ moieties. This is consistent with the above proposed mechanism; competition between apolar and polar species for hydration has resulted in two carboxylate anions in 100 residues effectively destructuring a majority of the water of hydrophobic hydration.

Although the discussion above is general to the phenomenon of controlling inverse temperature transitions in bioelastomers, regardless of whether those materials have the light energy coupled transduction properties of the invention, it will be recognized that the same discussion is relevant to varying the inverse temperature transition of compositions of the invention. Controlling the value of Tₜ is a dominant means whereby the folded and assembled states of protein and protein-based bioelastic polymers are controlled in order to achieve function. As previously discussed, polymers of the invention incorporate light energy sensitive side chains of a sufficient number and of a reaction couple type to provide the desired light energy-sensitive effects. Providing a polymer with the light energy-sensitive effects of the invention, however, does not eliminate the other properties of these polymers. Accordingly, it is possible to achieve the various mechanochemical and thermochemical properties that have been previously described in, for example, bioelastic materials by providing a polymer that contains functional groups in addition to those required for light energy sensitivity. As taught herein, selection of appropriately sensitive second side chains, e.g. chemically sensitive side chains or large hydrophobic side chains (for pressure sensitivity), allow the potential free energy transductions between light energy and chemical, thermal, pressure, or electrical energy to occur using compositions of the invention. A polymer will have the inherent thermal and mechanical properties if it merely has the polymer backbone and the required inverse temperature transition. By providing side chains reactive to changes in light energy will allow light energy modulation to occur. Furthermore by additionally providing, for example, second side chains with chemical couple functionality will allow photochemical transductions to take place.

As discussed above, an unexpected relationship was observed between hydrophobicity and hydrophobic-induced pKa shifts. This phenomenon can be taken advantage of to allow “poising” of the polymer to enhance the efficiency of light energy transduction.

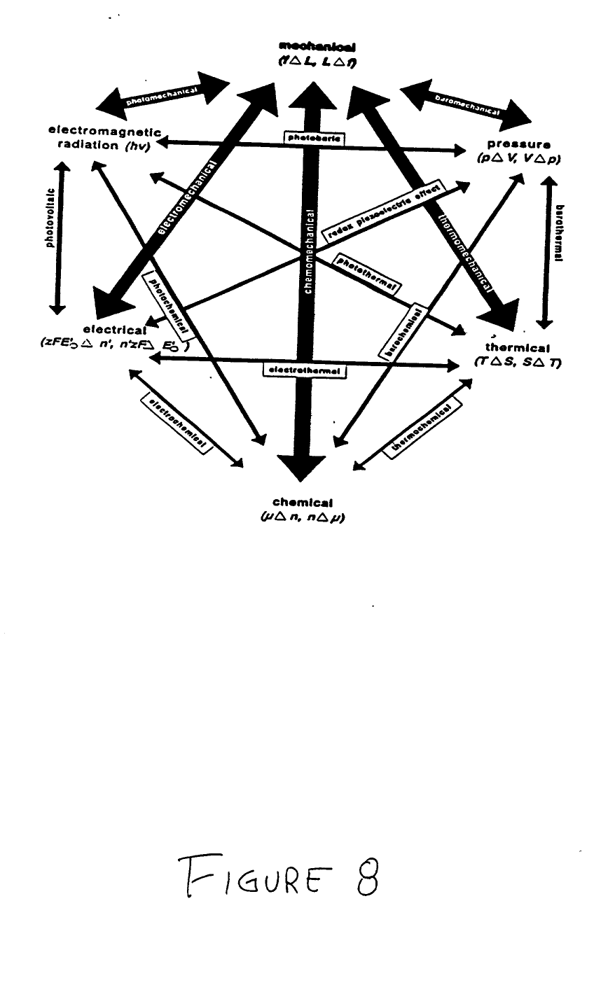

Using proteins of the structure poly[ƒᵥ(IPGVG),ƒₓ(IPGXG)] where ƒₓ is varied from 1 to 0.06 and for X=E(Glu), D(Asp) or K(Lys), it has been possible to delineate electrostatic-induced from hydrophobic-induced pKa shifts. Larger pKa shifts can be obtained in water when hydrophobic-induced than when electrostatic-induced (Reference 34, which is incorporated herein by reference). To determine how large the hydrophobic-induced pKa shifts can be, a series of polytricosamers, poly(30 mers) based on a series of six GVGVP repeats, were synthesized in which up to five of the twelve Val residues per 30 mer were replaced by the more hydrophobic Phe residues. When the five Phe residues were optimally placed with respect to the Glu or Asp residue consistent with the β-spiral structure of poly(VPGVG), pKa shifts as large as 3.8 were observed for Glu(E) and as large as 6.1 were observed for Asp(D). For the Asp case when only two of the five Phe replacements were included in the polytricosamer, the pKa shift is 0.4 and when the other three of the five Phe replacements were present, the pKa shift was 0.7. If the process were simply the displacement of higher dielectric water by the lower dielectric Phe residues, the substitutions of the first two and of the second three Val residues by Phe should be essentially additive, that is, 0.4+0.7=1.1, but instead the shift is 6.1. The magnitude of the shift is very non-linear with respect to number of Phe (hydrophobic) residues present in the polymer (FIG. 7).

Regarding hydrophobic-induced pKa shifts, an increase in pKa occurs for a carboxyl group upon an increase in hydrophobicity of the bioelastic unit. For amino groups and histidine a decrease in pKa occurs with increasing hydrophobicity. The direction of the pKa shift depends on which state of the group is more hydrophobic.

A comparison of pKa shift of polymer poly (GEGFP GVGVP GVGVP GVGVP GFGFP GFGFP) and poly (GEGFP GVGVP GVGFP GFGFP GVGVP GVGFP) unexpectedly shows that the latter polymer gives a greater pKa shift (Reference 52, which is incorporated herein by reference). The effect is unexpected since on the basis of primary structures, the Glu residues in the first polymer would experience greater hydrophobicity and would be expected to give the larger pKa shift. Only when the proper 3-dimensional conformation, in this case β-spiral folding, is taken into account does the spatial proximity become apparent, and the Glu-Phe proximity provides the understanding for the larger pKa shift exhibited by the latter polymer. Thus with regard to protein engineering of photoresponsive bioelastic polymers of the invention, increasing the 3-dimensional proximity of hydrophobic residues to either the photoresponsive group or the second side chain couple, in the case where either or both can undergo a pKa shift, will increase the magnitude of the pKa shift. The hydrophobicity-induced pKa shift effect exemplifies how to make and design polymers of the invention to fine-tune and control the photoresponsiveness of the polymers. The regularity of the polymer structures of the invention allows predictability of structure during polymer design, a feature not enabled by previously available random structure polymers such as poly acrylamides.

Mean residue hydrophobicities of a polymer can be calculated using the hydrophobicity scale for amino acids (Table 1) and the method of Urry et al. (44 and 52, which are both incorporated herein by reference).

The unexpected non-linearity of hydrophobic-induced pKa shifts is depicted in FIG. 7 for polymers containing a protonizable residue, e.g. glutamic acid, aspartic acid, or histidine, with increasing numbers of hydrophobic phenylalanine residues. Example 5 exemplifies the design of bioelastic polymers of the invention to poise the polymer for a greater response to light energy, in this case a pKa shift. Effects such as pKa shift not only increase with increasing hydrophobicity designed into the polymer, but increase in a non-linear way. Enhancement of other effects can be elicited by poising including expansion/contraction, oxidation/reduction, ionization/deionization, salt uptake/release and light-energy coupled transductions.

Preferred chromophores are those that can be attached, positioned and oriented along the polymer. A preferred photoresponsive reaction that results in a change in hydrophobicity or polarity of the side-chain is cis-trans isomerization. Cis-trans isomerization of double and partially double bond character is preferably attained using azobenzene, stilbenes, cinnamic acid, cinnamaldehyde or other analogs, retinoic acid, retinaldehyde, carotenoids, bilirubin, biliverdin, urobilin, luciferin and porphyrins. Most preferred photoresponsive groups are azobenzene, cinnamic acid, cinnamaldehyde and spiropyran. Also preferred are analogs of the above photoresponsive molecules, particularly their naturally occurring breakdown products that retain photoresponsiveness. Molecules providing rotation around amide bonds in response to light energy are also preferred. Also preferred photochemical reaction is light induced cleavage of molecules that result in charged species or complexes resulting in sufficient polarity changes. Preferred compounds of this type are spiropyrans, triarylmethane leuco derivatives and dyes.

Cross-linking of a polymer solution to form an elastic matrix can be performed using various cross-linking process, e.g. chemical, enzymatic, irradiative. U.S. Pat. No. 4,589,882, incorporated herein by reference, teaches enzymatic cross-linking by synthesizing block polymers having enzymatically cross-linkable units. If radiation is used to cross-link polymer embodiments of the invention and reversible light energy transduction is desired, then the side chain substituents responsible for the Tₜ effect are chosen so as to be non-reactive or minimally reactive to the cross-linking irradiation, e.g. its frequency, intensity, when compared to the groups to be cross-linked.

The light energy-sensitive materials of the invention can be used in a variety of different methods, apparatuses that perform work, and devices that indicate changes in light energy or transduce other types of free energies. It will be apparent that useful mechanical and/or chemical work can be obtained from the expansions and contractions of the compositions of the invention with changes in light energy and that such work can be used in a variety of situations, particularly in sealed systems or systems susceptible to contamination and that therefore are difficult to mechanically manipulate from outside the system. The follow examples of methods, apparatuses, and devices are only a few of the many possible variations.

It is understood that the limitations pertinent to the photoresponsive bioelastic polymers of the invention also pertain to compositions, apparatuses and machines containing those polymers and to methods of making of those polymers. For example, preferred compositions are those containing a bioelastomeric polymeric material containing bioelastomeric repeating units selected from the group consisting of bioelastic pentapeptides, tetrapeptides, and nonapeptides, wherein at least a fraction of said units contain an amino acid residue having a photoresponsive side chain. And, for example, useful compositions for Tt-type second order energy transductions include those wherein the bioelastic polymer further contains at least a fraction of bioelastomeric repeating units having a second amino acid residue with a side chain capable of undergoing a chemical change.

One method of the invention produces mechanical work by changing exposure to light energy on a composition of the invention as described above. The composition, usually a polymer in an aqueous environment surrounded by bulk water so that water can move into and out of the polymer as transitions occur, is constrained so that expansion and/or contraction of the polymer produces mechanical work. One manner of providing the desired light energy change on the composition is to provide the composition in a aqueous environment and to change the light energy. The change can be, for example, an increase or decrease in the intensity of the light energy, a change in the frequency or wavelength, or a change in the presence or absence of the radiation. The light energy can be provided by known methods such as a flash unit or laser light. Either macro or micro methods of light energy exposure are known in the art and are suitable for light energy delivery.

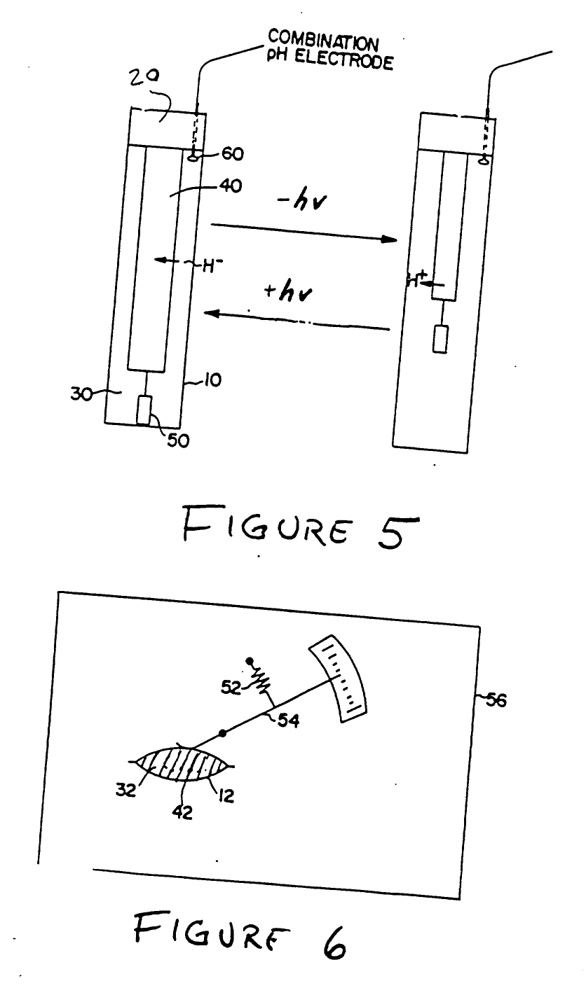

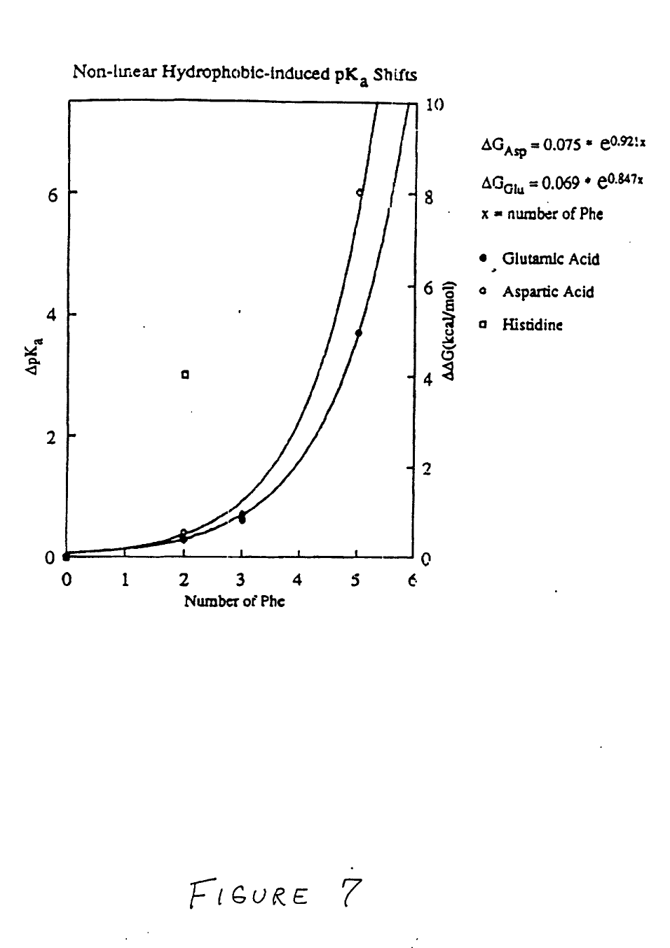

As an example, an apparatus for producing mechanical work can be prepared that contains a polymer or other material of the invention that is constrained so that expansion or contraction of the polymer will produce mechanical work. When the light energy exposure of the polymer is changed, the polymer will expand or contract to produce the desired work. An example of such a system is shown in FIG. 5 in which a light energy transparent container 10 having a cap 20 encloses an aqueous medium 30 containing a composition of the invention 40. The composition is prepared in the form of a strip, with one end of the strip being attached to a fixed location in the container (illustrated by attachment to cap 20) and the other end being attached to the object being moved 50. This object is illustrated by a suspended weight 50 in FIG. 5 but could be a lever, switch, or other mechanical operation. Depending on the light energy-sensitive group provided in the polymer a change in the light energy can either cause the weight suspended in the transparent cylinder to be lowered (i.e., moving from the right panel of FIG. 5 to the left panel) or to be raised as the supporting strip contracts. The weight may be replaced by a piston such that expansion 0 contraction of the polymer in response to light energy causes movement of the piston to produce useful mechanical work.

An alternative apparatus for producing useful work uses a deformable, light energy transparent sheath 12 (e.g., a sealed flexible plastic container) surrounding an aqueous medium 32 containing a composition of the invention 42. Changing the exposure to light energy of the sheath causes the composition of the invention to contract or expand, allowing motion to be imparted to an object contacting the sheath so that it moves through a distance against an opposing force (such as a spring 52). The object can be, for example, a lever 54 that functions as the movement arm of a light gauge 56. A polymer 42 capable of irreversible reaction in response to light energy would cause the meter to serve as an indicator of a light energy event.

When functional groups capable of undergoing reversible chemical change are included in the light energy-sensitive compositions as discussed above, chemical changes can be caused to occur in systems merely by changing the light energy on the system. For example, if the chemical change is protonation, a pH change can be caused in the environment surrounding a composition of the invention by changing the light energy exposure to the composition, which effects a change in the contraction/expansion of the composition such that a change in the pKa of the composition and a resulting change of pH in the environment results. This method can readily be embodied in an apparatus. For example, when the previously described container of FIG. 5 encloses an aqueous medium containing a composition of the invention that contains ionizable functional groups, a change of pH in the aqueous medium will occur merely by changing the light energy exposure (to result in expansion or contraction) without requiring introduction of reagents into the medium.

In one embodiment, light energy can be measured through changes in pH of the aqueous medium surrounding a composition of the invention as the aqueous medium undergoes changes in exposure to light energy. Referring again to FIG. 5, container 10 and cap 20 can be fitted with pH electrode 60 inserted through the wall of the container or cap. A composition of the invention 40 is enclosed in this container along with bulk water. The mechanochemical constraint, as exemplified by weight 50, is not required in this embodiment. As the light energy exposure on the composition changes and results in either a contraction or expansion of the composition 40, pKa changes in the composition will cause pH changes in the surrounding water. It is merely necessary to have the scale of the pH meter calibrated in units of light energy intensity to have the system provide a direct light energy reading at a remote location.

Compositions of the invention are also useful in situations where contraction beyond that applied through mechanical means is desired. For example, one useful application for the composition of the invention is therefore as surgical sutures, particularly for microsurgical procedures. Sutures made from compositions of the invention can be used in anastomosis, for example, and with subsequent application of light energy contract (irreversibly if the appropriate photoresponsive group is present in the polymer) and tighten to the degree desired. Particularly preferred for this purpose are materials based on elastomeric pentapeptide, tetrapeptide, and nonapeptide monomers as described herein, as these material have already been demonstrated to be biocompatible. See the various patents and patent applications listed above dealing with biocompatible uses of these materials and the formation of these materials into such devices. Although these prior patents and applications have not been concerned with photoresponsive polymer compounds, they provide considerable guidance on biocompatibility and on manufacturing of bioelastomers to obtain useful structural and surface features for biomedical uses.

Membranes comprised of bioelastic polymers are another useful embodiment of the invention that provides an alternative to “heat-shrinking” as means of achieving a tight sealing of a membrane or sheath across an area or around an object. The application of light energy of a particularly type or intensity to a membrane made from bioelastic polymers can induce contraction of the polymer resulting in shrinking of the membrane or sheath. The shrinking can be reversible or irreversible depending on the choice of reactive group as taught herein.

The photo-chemical reaction of the cinnamic acid moiety attached to the aspartic acid of the bioelastic polymer of Example 3 is irreversible. The irreversibility facilitates the experimental measurement of polymer activities, in this case a pKa shift, during the design of polymers of the invention. In addition, irreversible photo-responses in bioelastic polymers allows use of such polymers as indicators of total exposure to light energy. For example, films comprised of irreversible photoresponsive bioelastic polymers of the invention when located on photographic film find use as an indicator of exposed film. Photoresponsive bioelastic polymers that also undergo a visible color change upon a change in exposure to light, e.g. cinnamic acid derivatized polymer, are preferred for indicators; however, in the absence of a color change, indication can be reflected as a visible morphological change in the polymer film, e.g. turbidity, wrinkling, caused by the contraction or expansion of the polymer film.

One or more of the peptide bonds can be optionally replaced by substitute linkages such as those obtained by reduction or elimination. Thus, one or more of the —CONH— peptide linkages can be replaced with other types of linkages such as —CH₂NH—, —CH₂S—, CH₂CH₂—, —CH═CH— (cis and trans), —COCH₂—, —CH(OH)CH₂— and —CH₂SO—, by methods known in the art, for example, see Spatola, A. F. (1983) in Chemistry and Biochemistry of Amino Acids, Peptides and Proteins (B. Weinstein, ed.) Marcel Dekker, New York, P. 267 for a general review. Amino acid residues are preferred constituents of these polymer backbones. Less preferred constituents are amino acid homologs. Although photoresponsive groups and second side chain reaction couple groups are preferably attached using known amino acid and protein chemistry methods to functional reactive groups on amino acid chain side chains, the linkage is not critical so long as it does not hinder the photoresponse or second side chain couple reaction, allows the desired positioning of the side chains to achieve effects such as poising, and does not disrupt the bioelastic units structure necessary to achieve an inverse temperature transition. Of course, if desired a linkage can be chosen to modulate either side chain response.

Of course, if backbone modification is made in the elastomeric units, then suitable backbone modifications are those in which the elasticity and inverse temperature transition of the polymer is maintained.

The choice of individual amino acids from which to synthesize the elastomeric units and resulting polypeptide is unrestricted so long as the resulting structure comprises elastomeric structures with features described, for example, in U.S. Pat. Nos. 4,474,851 and 5,064,430, particularly β-turn formation, and incorporate light energy responsive side chains as disclosed in the present application.

As disclosed in earlier U.S. Patents, additional properties, e.g. strength, specific binding, are imported to bioelastomeric materials by compounding the repeating elastic units to a second material with greater strength or with the desired property as disclosed, in U.S. Pat. Nos. 4,474,851 and 5,064,430.

By biological compatible is meant that the material in final form will not harm the organism or cell into which it is implanted to such a degree that implantation is as harmful or more harmful than the material itself.

Such compounding can be oriented in the backbone of the polymer by preparing copolymers in which bioelastic units that form β-turns are interspersed among polymer units providing a desired property e.g. cell adhesion sequences containing Arg-Gly-Asp.

This new type of biomaterial can be designed for a diverse set of applications, thereby complementing and extending the uses for bioelastic materials described in the numerous patents and patent applications by this inventor. Light energy induced changes in the Tₜ of a target bioelastomeric peptide allows for non-invasive methods of effecting a desired result. For example, a drug delivery matrix (see this inventor's U.S. patent application Ser. No. 07/962,608, filed Oct. 16, 1992, which is incorporated herein by reference) comprised of a photosensitive bioelastic polymer of the present invention which releases its drug upon a change in light energy such as a change in light intensity, finds use, for example, in tissue culture where the delivery of drugs or other factors to cells at a desired point in time can be achieved without necessitating invasive procedures that would increase the chance of culture contamination or a change in other culture conditions. Similarly, drug delivery can occur in vivo by administration of a drug-impregnated bioelastic matrix that is designed to change Tₜ and contract and release its drug in response to dark adaption. Controlled drug release and/or degradation of the drug-impregnated bioelastic matrix can be achieved by incorporating light sensitive side chain groups that upon dark adaptation obtain the properties of side-chain groups taught in U.S. patent application Ser. No. 07/962,608, such as functional groups that are susceptible to hydrolysis upon dark adaptation. The drug-impregnated or containing matrix can be of a sponge-type or of an envelope type. Drug delivery can be extended to controlled pesticide or herbicide release. These are but some examples of the use of the bioelastic peptides of the invention for the transduction of (change in) light energy to useful mechanical work.

This inventor's U.S. Pat. No. 5,032,271, describes an apparatus containing a bioelastic polymer that is capable of desalination sea water or brackish water with the assistance of an applied mechanical force, converting mechanical to chemical energy. The light energy-reactive polymers of the present invention provide an apparatus for desalination that can be driven by light energy, in this case solar energy can be used. By analogy to FIG. 7 of U.S. Pat. No. 5,032,271, in one embodiment, a solar-driven desalinator involves an expandable container, having an water fill port and a drain port, and containing a bioelastic polymer of the invention (capable of reversible reaction) in a relaxed state in salt water. Upon a change in exposure of the polymer to solar energy, the polymer expands. Expansion of the polymer exposes hydrophobic groups and the polymer uptakes water as the exposed hydrophobic groups become surrounded with clathrate-like water. Since the uptake of ions from the solution is not favored by the hydrophobicity of the polymer, the water taken up is lower in ions than the starting salt water. The excess water which is high in salt is drained from the container while the polymer stretches. By returning the exposure of light energy to the starting state, the polymer will contract causing an extrusion of water which is lower in salt concentration. The process can be repeated using with the reversibly responding polymer to until the salt water is effectively desalted. This is but another example of how the present invention enables extends the applications of previously known bioelastic polymers.

The invention now being generally described, the same will be better understood by reference to the following examples, which are provided for purposes of illustration only and are not to be considered limiting of the invention unless so specified.

### EXAMPLES

### Example 1

Synthesis of a Model Photoresponsive Bioelastomer.

Copolymers I and II have the following formula:

poly[ƒᵥ(VPGVG),ƒₓ(VPGXG)]ₙ,

where

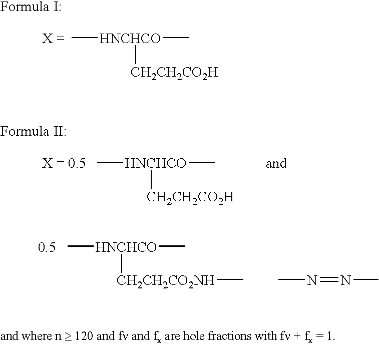

The copolypeptide of Formula I was synthesized as previously described (Urry et al. (1992) Biopolymers 32:373-379, which is incorporated herein by reference) and verified by nuclear magnetic resonance. The mole fractions of pentamers, determined by amino acid analyses were ƒv=0.68 and ƒx=0.32, i.e., I is represented as poly[0.68(VPGVG), 0.32(VPGEG)].

The photosensitive copolypeptide of Formula II was prepared in the following manner. Copolypeptide I (31.6 mg, 0.019 mmol of —CO₂H) was dissolved in 2 mL of N,N-dimethylformamide (DMF). To this solution was added 8.2 mg (0.042 mmol) of phenylazoaniline, 6.6 mg (0.049 mmol) of hydroxybenzotriazole, and 8.2 mg (0.040 mmol) of dicyclohexylcarbodiimide. The solution was stirred for 3 days at room temperature, and 1 drop of 1M acetic acid was added to facilitate precipitation of the dicyclohexylurea by-product. The precipitate was removed by centrifugation and the polymer was recovered by precipitation into excess diethyl ether, washed repeatedly with ether, and then dried overnight at 40° C. The yield in this case was 28.2 mg (89%). Thin layer chromatography reveal no contamination by unconjugated phenylazoaniline and the ultraviolet absorption spectrum indicated amidation of 55% of the glutamic acid side chains of I. The molar extinction coefficient reported by Fissi and Pieroni (40) for poly(L-glutamic acid) containing 85 mol % azobenzene units in the side chains was used to estimate the degree of amidation. The absence of observable phenylazoaniline from the thin layer chromatogram limits the amount of the unconjugated chromophore to less than 0.5% of the amount bound to the polypeptide.

### Example 2

Photo-Modulation of Polymer Properties

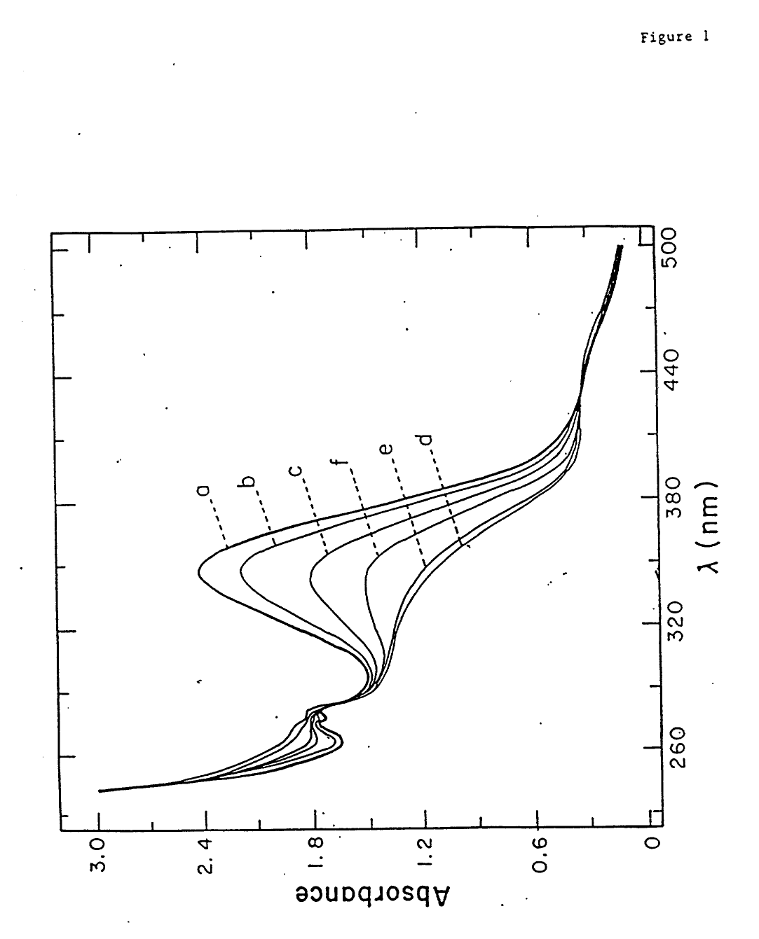

FIG. 1 shows the changes in the electronic absorption spectrum of II that occur upon irradiation of a 0.5 wt % solution of the copolymer in phosphate-buffered saline (0.15 N NaC1/0.01 M sodium phosphate, pH 3.5). The dark-adapted copolymer exhibited the expected absorption spectrum of the trans azobenzene chromophore, with absorption maxima at 348 nm and 428 nm (curve a). Irradiation at 350 nm (Rayonet minireactor, four 350 mn lamps) resulted in reduction in the intensity of the 348 nm absorption band, with the photostationary state being reached in approximately 45 seconds under the conditions of this experiment (curves b-d). The photostationary state consisted of ca. 30% of the trans and 70% of the cis forms of the chromophore under these conditions of irradiation (41). Further irradiation from a longer wavelength source (a Sunpak Thyristor Auto 522 electronic flash unit with the window removed) restored the 348 nm absorption, via partial photoreversion to the trans form of the chromophore (curves e and f). The state represented by curve f did not change upon further irradiation, and was estimated to consist of approximately 50% trans and 50% cis chromophore. The tight isosbestic points at 280 and 425 nm indicated that the cis-trans interconversion occurs without significant degradation of the chromophore.

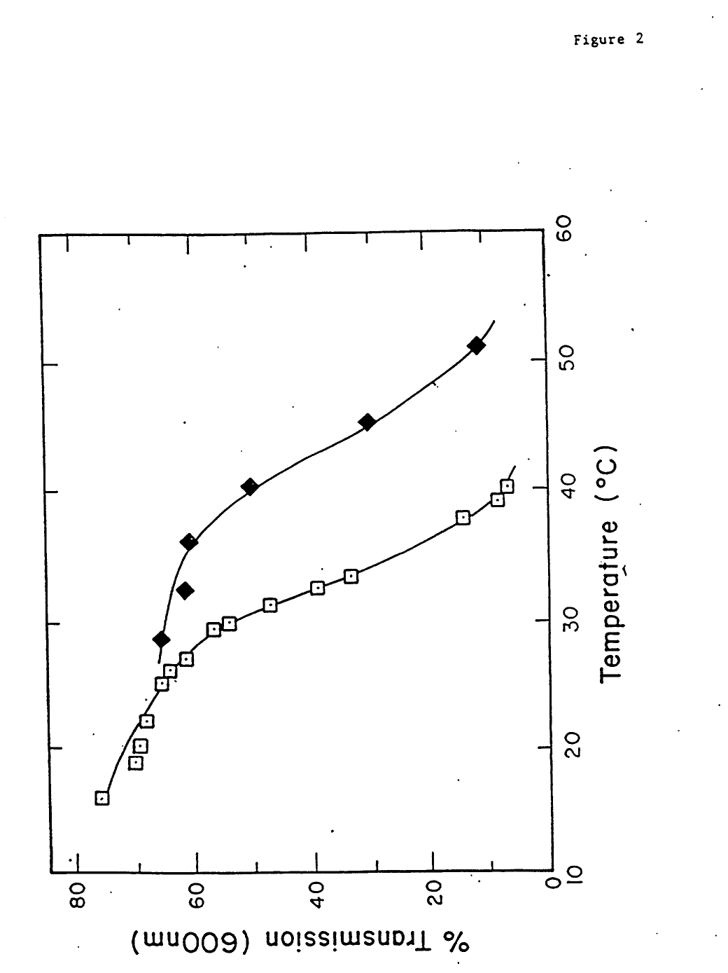

FIG. 2 shows that the inverse temperature transition of II was sensitive to the configuration of the azobenzene chromophore. Phase separation of the polymer, as reported by an abrupt increase in the turbidity of the sample, occured at approximately 32° C. for the trans form and at approximately 42° C. for the cis form of II when buffered at pH 4.1. Elevation of the transition temperature upon trans-to-cis photoisomerization was consistent with the increased dipole moment of the cis azobenzene isomer (42) and with the established correlation between the polarity of the side chain and the temperature at which phase separation was observed (43,44).

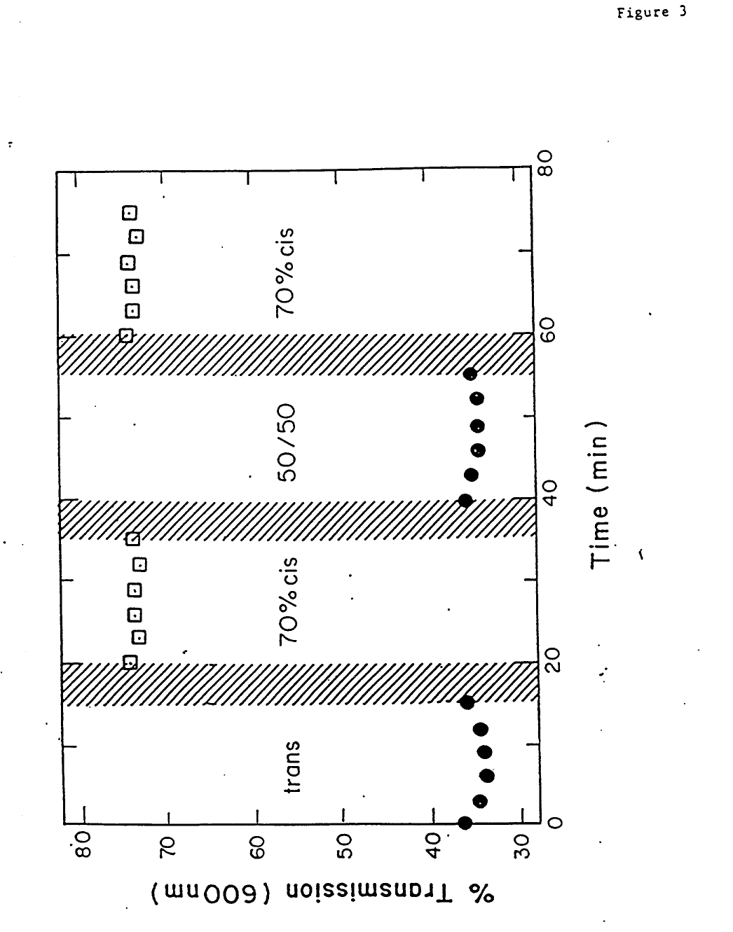

The shift in phase transition temperature from 32° C. to 42° C. upon trans-to-cis isomerization opens a window, near 40° C., for photomodulation of the transition at a constant pH of 4.1, which is illustrated in FIG. 3. At 40° C., the relatively hydrophobic trans form of the polymer affords turbid suspensions. Irradiation at 350 nm resulted in conversion to the 70% cis form, with corresponding dissolution of II and decreasing sample turbidity. Further irradiation from the longer wavelength source reformed approximately 50% of the hydrophobic trans isomer and drove a second cycle of phase separation. Thermal reversion of the cis isomer under these conditions was negligible, and the process was fully reversible under photocontrol.

These results illustrate that attachment of one azobenzene chromophore in 1 5 approximately forty amino acid residues was sufficient to render photosensitive the inverse temperature transition of elastin-like polypeptides. And that reversible photomodulation of the transition isothermally, in this case at 40° C., was achieved.

### Example 3

Synthesis and Photo-modulation of a Polymer Containing Cinnamic Acid.

Trans-cinnamic acid derivatized polypentapeptide (amide linkage) was synthesized in the following manner by covalently attaching the acid group to the polymer via an amide linkage. 150 mg of poly[3(GVGVVP)(GKGVP)] polymer containing 5 lysine/100 amino acid residues (0.082 mmol) was dissolved in 15 ml N,N-dimethyformamide and cooled with drying tube attached to −10 C. in methanol/ice bath. 40 ul N-methylmorpholine (NMM) was added to adjust the pH between 7 and 8. Trans-cinnamic acid (0.4g, 2.7 mmol) was placed in a 100 ml flask with 15 ml DMF. Hydroxybenzotriazole (HOBt) (0.37g, 2.7 mmol) was added and the solution cooled to −10C. with drying tube attached. When cooled ethyl-3-(3-dimethylamino)-propyl carbodiimide HCl (EDCI) (1.04g, 5.4mmol) was added and let react 20 minutes with stirring while maintaining at least −10 C. The cold polymer solution was then added to the cinnamic acid mixture and the temperature allowed to warm up to room temperature over a period of several hours. The reaction was then stirred for 3 days at room temperature. The DMF was removed under reduced pressure and the residue redissolved in 50:50 DMF/H₂O. This was dialyzed against cold distilled water which caused precipitation of the material. The dialyzate was filtered, freeze-dried and found to contain no material. The filtered material was then washed with 5×25 ml aliquots of ethyl acetate and dried yielding 200 mg. Repeated extraction with ethyl acetate finally yielded 105 mg of off-white material (67%). The cinnamic acid derivatized polypentapeptide was water insoluble but could be solubilized in urea or guanidine HCl solutions. Comparison of UV spectra of the polymer and free acid in ethanol indicated essentially 100% of the lysine groups were coupled to trans-cinnamic acid.

Changes in the inverse transition temperature, an increase in the value of Tₜ, were observed after irradiation with 254 nm or 300 nm light sources in 2 mg/ml urea or guanidine hydrochloride solutions. Further, cross-linked polymer bands exhibited the ability to move an attached weight in response to a change in exposure to light energy.

### Example 4

Synthesis of and Photo-Modulation of a Polypentapeptide Polymer Containing Cinnamaldehyde.

To 75 mg of polypentapeptide containing ˜2/100 lysine residues in 10 ml DMF at room temperature was added 100 μl of trans (99% +) cinnamaldehyde.

After stirring for three hours at room temperature the DMF was removed under reduced pressure at 45° C. The oily residue was washed ten times with 10 ml aliquots of ether. The resulting polypentapeptide polymer containing cinnamaldehyde via a Schiff base linkage was dissolved in water and subsequently freeze-dried. Yield was 78 mg.

The inverse temperature transition of a 10 mg/ml solution in 0.15 N NaCl at pH 6.6 was shifted after irradiation with 300 nm light source. The absorption changes of the chromophore reverted to that of the pre-irradiated sample after 24 hrs. and the cycle could be repeated a second time.

### Example 5

Designing Polytricosamer Peptides Poised for Greater Light Effect.

Four tricosamers were synthesized and cinnamic acid was then attached via an amide linkage using lysine residues in specific positions relative to that of the phenyl and aspartic residues. The sequences synthesized were:

Poly(GDGFP GVGVP GVGFP GKGVP GVGVP GVGFP): CG1582

Poly(GDGFP GVGVP GVGFP GFGVP GVGVP GVGKP): CG1583

Poly(GDGFP GVGVP GVGVP GKGVP GVGVP GVGFP): CG1584

Poly(GDGFP GVGVP GVGVP GFGVP GVGVP GVGKP): CG1585

The tricosapeptides (fixed sequences) were synthesized by the [(5+5+5)+(5+5+5)] fragment coupling strategy in the classical solution methods. The pentamers required for this purpose were synthesized as previously described. In the syntheses, the Boc group was used for N^{α}-protection, the cyclohexyl group for Asp side chain, and trifluoroacetyl for N^{ε} Lys protection. The C-terminus carboxyl group was protected by the benzyl ester, and its removal was effected by hydrogenolysis using H₂/Pd—C(10%). All coupling reactions and deblocking were achieved by EDCI/HOBt and TFA, respectively. For polymers, the tricosamer acids were deblocked and a one-molar solution of each TFA salt was polymerized using EDCI and HOBt in the presence of 1.6 equivalent of NMM as base. After 14 days, the polymers were then each dissolved in water, dialyzed using 3500 mol wt. cut-off dialysis tubing and lyophilized. The Asp side chain protection was carefully deblocked using HF:p-cresol (90:10,v/v) for 1 h at 0 degrees C. The polymers were then dissolved in water, base treated with 1N NaOH to remove trifluoroacetyl group, dialyzed using 50 kD mol. wt. cut-off dialysis tubing and lyophilized.

The trans-cinnamic acid was attached to the lysine residue via amide linkage using EDCI/HOBt as coupling agent. The excess reagents and side products were removed by dialysis.

When the pKa of the Asp(D) residue was determined by an acid-based titration, the pKa was lowered after irradiation with ultraviolet light. The magnitude of the decrease in pKa was greater for CG1583 which contained three Phe residues per tricosamer than for CG1585 which contained two Phe residues per tricosamer. This is an example of poising in which the same change in hydrophobicity brought about by the light reaction causes larger effects when the overall hydrophobicity within the tricosamer is greater.

### Example 6

Spiropyran Derivatized Polypentapeptide.

A spiropyran derivatized polypentapeptide in which spiropyran was attached to the polymer by an ester linkage was prepared as follows. To 102 mg of poly[4(GVGVP)(GEGVP)] containing approximately 2 Glu residues per 100 residues (as determined by amino acid analysis) in 12 ml DMF in a 50 ml flask was added 175 mg (OH-Et-BIPS) 1-(β-hydroxyethyl)-3,3-dimethyl-6′-nitrospiro (indoline-2,2′ [2H-1] benzopyran), 51.5 mg (DCCI) dicyclohexyl-dicarbodiimide and 3.7 mg (PPD) 4-pyrrolidinopyridine. A drying tube was attached to flask and the reaction allowed to proceed for 72 hrs. at room temperature in the dark. The DMF solution was then extracted with 15 ml cold 4M urea and then repeatedly with ethyl acetate to extract excess dye and reagents. The protein material was dialyzed against cold distilled water and freeze-dried. Yield was 97 mg of pale purple material.

A 10 mg/ml solution of the above material was made up in water containing 0.1% Na ascorbate and 0.025% Mg SO₄.7H₂O. The sample was left overnight in cold to completely solubilize and dark adapt.

A lowering of the inverse temperature transition was observed after irradiation with the room fluorescent lights.

All publications and patent applications mentioned in this specification are herein incorporated by reference to the same extent as if each individual publication or patent application was specifically and individually indicated to be incorporated by reference at the location where cited.

The invention now being fully described, it will be apparent to one of ordinary skill in the art that many changes and modifications can be made thereto without departing from the spirit or scope of the appended claims.

What is claimed is:

1. An photoresponsive bioelastic polymer, comprising:
a bioelastomeric polypeptide repeating unit having an inverse temperature transition, wherein at least one amino acid residue in the bioelastomeric unit has a side chain that responds to a change in exposure to light energy to effect a change in polarity or hydrophobicity of the side chain and is present in sufficient amount to provide a shift in the temperature of inverse temperature transition of the polymer upon the change in exposure to light energy.

2. The photoresponsive bioelastic polymer of claim 1, wherein the light energy is in the ultraviolet, visible or infrared range.

3. The photoresponsive bioelastic polymer of claim 1, wherein response of the photoresponsive side chain upon a change in exposure to light energy is isomerization, oxidation, reduction, ionization, deionization, protonation, deprotonation, amidation, deamidation, dimerization, cleavage, or addition.

4. The photoresponsive bioelastic polymer of claim 1, wherein the reaction of the photoresponsive side chain is reversible.

5. The photoresponsive bioelastic polymer of claim 1, wherein only a fraction of bioelastomeric repeating units in the polymer contain said side chain that responds to a change in exposure to light energy.

6. The photoresponsive bioelastic polymer of claim 1, wherein the temperature of inverse temperature transition is in the range of liquid water.

7. The photoresponsive bioelastic polymer of claim 1, wherein the bioelastomeric units are selected from the group consisting of bioelastic pentapeptides, tetrapeptides, and nonapeptides.

8. The photoresponsive bioelastic polymer of claim 1, which further comprises a second amino acid having a side chain capable of undergoing a change in an aqueous environment.

9. The photoresponsive bioelastic polymer of claim 8, wherein said second amino acid side chain undergoes a chemical change.

10. The photoresponsive bioelastic polymer of claim 1, wherein the change in hydrophobicity of the photoresponsive side chain is equal to or greater than the hydrophobicity of a CH2 group.

11. A composition that expands or contracts upon a change in exposure to light energy, which comprises:
a polymeric material having an inverse temperature transition, wherein at least a fraction of the bioelastomeric repeating units in said polymer contain a photoresponsive side chain that responds to a change in exposure to light energy to effect a change in the polarity or hydrophobicity of the side chain and that is present in sufficient amount to provide a shift in the temperature of inverse temperature transition of the polymer upon the change in exposure to light energy.

12. The composition of claim 11, wherein the polymer comprises a series of β-turns separated by dynamic bridging segments suspended between said β-turns.

13. The composition of claim 12, wherein the polymer consists essentially of polypeptide bioelastomeric units, each of which comprises a β-turn.

14. The composition of claim 12, wherein the polymer comprises multiple polypeptide bioelastomeric repeating units, each of which comprises a β-turn, and further comprises intervening polypeptide segments between at least some bioelastomeric repeating units.

15. The composition of claim 11, wherein at least a fraction of said elastomeric units comprise a VPGVG repeating unit.

16. The composition of claim 15, wherein the polymer comprises a segment having the formula poly[ƒₓ(VPGXG),ƒᵥ(VPGVG)] where fₓ and fᵥ are mole fractions with fₓ+fᵥ=1 and X represents said amino acid residue having a photoresponsive side chain.

17. The composition of claim 16, wherein said polymer comprises a segment having the formula poly[fₓ(VPGXG),fᵥ(VPGVG),f_{z}(VPGZG)] where fₓ, fᵥ, and fᵥ are mole fractions with fₓ+fᵥ+f_{z}=1, X represents the amino acid residue having a photoresponsive side chain, and Z represents an amino acid residue having a side chain capable of undergoing a chemical change in an aqueous environment.

18. A method of producing mechanical work, which comprises:
changing light energy exposure on a bioelastic polymer containing bioelastomeric units having an inverse temperature transition, wherein at least one amino acid residue in a bioelastomeric unit has a side chain that responds to a change in exposure to light energy to effect a change in the polarity or hydrophobicity of the photoresponsive side chain and that is present in sufficient amount to provide a shift in the temperature of inverse temperature transition of the polymer upon the change in exposure to light energy, and wherein said polymer is constrained so that expansion or contraction of said polymer produces mechanical work.

19. The method of claim 18, wherein when the light exposure is changed an object in contact with the polymer which is under the influence of a force resisted by the polymer moves under the influence of the force as the polymer contracts or expands.

20. An apparatus for producing mechanical work, which comprises:
a bioelastic polymer containing bioelastomeric units having an inverse temperature transition, wherein at least one amino acid residue in a bioelastomeric unit has a side chain that reacts to a change in exposure to light energy to effect a change in the polarity or hydrophobicity of the photoresponsive side chain and is present in sufficient amount to provide a shift in the temperature of inverse temperature transition of the polymer upon the change in exposure to light energy;
means for constraining said polymer wherein expansion of said polymer will produce mechanical work; and
means for applying a change in exposure in light energy to the polymer, whereby a change in the light energy causes the polymer to expand and produce the mechanical work.

21. A method of producing a pH change in an environment, which comprises:
locating in said environment a bioelastic polymer containing bioelastomeric units having an inverse temperature transition, wherein (1) at least one amino acid residue in a bioelastomeric unit has a side chain that reacts to a change in exposure to light energy to effect a change in the polarity or hydrophobicity of the photoresponsive side chain and that is present in sufficient amount to provide a shift in the temperature of inverse temperature transition of the polymer upon the change in exposure to light energy, and (2) at least a fraction of said bioelastomeric units contain at least one amino acid residue with a side chain capable of undergoing reversible protonation, and
applying a change in exposure to light energy to said environment, whereby the light energy change causes a change in the pKa of the polymer and a resulting change of pH in the environment.

22. An apparatus for producing changes in pH in an environment, which comprises:
a bioelastic polymer containing bioelastomeric units having an inverse temperature transition, wherein (1) at least one amino acid residue in a bioelastomeric unit has a side chain that reacts to a change in exposure to light energy to effect a change in the polarity or hydrophobicity of the side chain and that is present in sufficient amount to provide a shift in the temperature of inverse temperature transition of the polymer upon the change in exposure to light energy; and
means for applying a change in exposure to light energy to said polymer, whereby the change in light energy causes said polymer to undergo a change in pKa and change the pH in the environment.

23. A photoresponsive bioelastic polymer machine of the first order Tₜ-type, comprising the photoresponsive polymer of claim 1.

24. A photoresponsive bioelastic polymer machine of the second order Tₜ-type, comprising the composition of claim 8.

25. A photochemical device for desalinating sea water or brackish water by the conversion of electromagnetic energy to chemical work, which comprises:
a) a housing containing an bioelastomeric material capable of stretching in response to a change in exposure to light energy to thereby allow salt-diminished water to move into the bioelastomeric material while substantially repelling solvated salt ions from entry thereto,
b) means for application of a change in exposure of light energy to the bioelastic polymer in the housing,
c) means for uptake of the sea water or brackish water into the housing, means for draining concentrated saltwater from said housing, and means for draining desalinated water from the housing;
wherein the bioelastomeric material is capable of reversibly contracting and relaxing by means of an inverse temperature transition shift induced by light energy.


SEQUENCE LISTING (20 sequences)

SEQ ID NO: 1 - protein, 5 aa, Artificial Sequence
  Synthetic sequence
VPGVG

SEQ ID NO: 2 - protein, 4 aa, Artificial Sequence
  Synthetic sequence
VPGG

SEQ ID NO: 3 - protein, 10 aa, Artificial Sequence
  Synthetic sequence
VPGVGVPGXG

SEQ ID NO: 4 - protein, 10 aa, Artificial Sequence
  Synthetic sequence
VPGVGVPGGG

SEQ ID NO: 5 - protein, 10 aa, Artificial Sequence
  Synthetic sequence
GVGVPGPGVP

SEQ ID NO: 6 - protein, 5 aa, Artificial Sequence
  Synthetic sequence
GPGVP

SEQ ID NO: 7 - protein, 5 aa, Artificial Sequence
  Synthetic sequence
IPGVG

SEQ ID NO: 8 - protein, 10 aa, Artificial Sequence
  Synthetic sequence
IPGVGIPGGG

SEQ ID NO: 9 - protein, 15 aa, Artificial Sequence
  Synthetic sequence
VPGXGVPGVGVPGXG

SEQ ID NO: 10 - protein, 5 aa, Artificial Sequence
  Synthetic sequence
VPGXG

SEQ ID NO: 11 - protein, 9 aa, Artificial Sequence
  Synthetic sequence
IPGVGIPXG

SEQ ID NO: 12 - protein, 5 aa, Artificial Sequence
  Synthetic sequence
GVGVP

SEQ ID NO: 13 - protein, 30 aa, Artificial Sequence
  Synthetic sequence
GGGPPGVGVPGVGVPGVGVPGPGPPGPGPP

SEQ ID NO: 14 - protein, 35 aa, Artificial Sequence
  Synthetic sequence
GGGPPGVGVPGVGPPGVGPPGPGPPGVGVPGVGPP

SEQ ID NO: 15 - protein, 10 aa, Artificial Sequence
  Synthetic sequence
GVGVPGKGVP

SEQ ID NO: 16 - protein, 30 aa, Artificial Sequence
  Synthetic sequence
GAGPPGVGVPGVGPPGLGVPGVGVPGVGPP

SEQ ID NO: 17 - protein, 30 aa, Artificial Sequence
  Synthetic sequence
GAGPPGVGVPGVGPPGPGVPGVGVPGVGLP

SEQ ID NO: 18 - protein, 30 aa, Artificial Sequence
  Synthetic sequence
GAGPPGVGVPGVGVPGLGVPGVGVPGVGPP

SEQ ID NO: 19 - protein, 30 aa, Artificial Sequence
  Synthetic sequence
GAGPPGVGVPGVGVPGPGVPGVGVPGVGLP

SEQ ID NO: 20 - protein, 10 aa, Artificial Sequence
  Synthetic sequence
GVGVPGGGVP